(19) United States
(12) Patent Application Publication
(10) Pub. No.: US 2022/0248074 A1
(43) Pub. Date: Aug. 4, 2022

(54) SYSTEMS AND METHODS FOR IMPROVING VIDEO, SEARCH, AND CLOUD APPLICATIONS

(71) Applicant: Meta Platforms, Inc., Menlo Park, CA (US)

(72) Inventors: Shankar Lakshmi Regunathan, Redmond, WA (US); Haixiong Wang, Sunnyvale, CA (US); Yun Zhang, Newark, CA (US); Yu Liu, Sunnyvale, CA (US); David Wolstencroft, Carlsbad, CA (US); Bakkama Srinath Reddy, Redmond, WA (US); Cosmin Vasile Stejerean, Las Vegas, NV (US); Sonal Gandhi, Seattle, WA (US); Minchuan Chen, Redmond, WA (US); Pankaj Sethi, Palo Alto, CA (US); Amit Puntambekar, Santa Clara, CA (US); Michael Hamilton Coward, Menlo Park, CA (US); David Ronca, Campbell, CA (US); Ioannis Katsavounidis, San Jose, CA (US); Zhen Liao, Los Altos, CA (US); Wenting Wang, Menlo Park, CA (US); Bi Xue, Palo Alto, CA (US); Hong Yan, Los Altos, CA (US); Guangdeng Liao, Los Altos Hills, CA (US); Yinzhe Yu, Palo Alto, CA (US); Qunshu Zhang, Sammamish, WA (US); Xiaoxing Zhu, Bellevue, WA (US); Yangpeng Ou, Redmond, WA (US); Jacob Matthew Okamoto, St. Paul, MN (US); Francisco Javier Merino Guardiola, Madrid (ES); Carlos Lopez Menendez, Madrid (ES); Christopher Wickersham Clark, Seattle, WA (US); Puttaswamy Rahul Gowda, Berkeley, CA (US); Yi Liu, Bellevue, WA (US); Qi Ding, Seattle, WA (US); Junjin Pu, Seattle, WA (US); Sakphong Chanbai, Bellevue, WA (US); Ming Cao, Bellevue, WA (US)

(21) Appl. No.: 17/727,387

(22) Filed: Apr. 22, 2022

Related U.S. Application Data
(60) Provisional application No. 63/318,126, filed on Mar. 9, 2022.
(60) Provisional application No. 63/272,653, filed on Oct. 27, 2021.
(60) Provisional application No. 63/271,538, filed on Oct. 25, 2021.
(60) Provisional application No. 63/271,071, filed on Oct. 22, 2021.
(60) Provisional application No. 63/256,711, filed on Oct. 18, 2021.

(51) Int. Cl. H04N 21/2662; H04N 21/239; H04N 21/443; H04N 21/24; G06F 16/738

(52) U.S. Cl. CPC H04N 21/2662; H04N 21/2396; G06F 16/738; H04N 21/2402; H04N 21/4437

(57) ABSTRACT

The disclosed computer-implemented method may include a process for monitoring and improving end-to-end video quality based on scaled and/or interpolated perceptual quality scores across various video views. The method may also include a process for improving search experience for user expectations. Additionally, the method may include a process for providing hardware virtualization and simulation for server hosting. Furthermore, the method may include a process for filtering network traffic in a hosting environment. The method may additionally include a process for testing applications in a hosting environment. The method may further include a process for supporting multi-touch applications. The method may also include a process for optimized graphics rendering. Various other related methods and systems are also disclosed.

### CROSS REFERENCE TO RELATED APPLICATIONS

This application claims the benefit of U.S. Provisional Application No. 63/256,711, filed 18 Oct. 2021, which claims the benefit of U.S. Provisional Application No. 63/271,071, filed 22 Oct. 2021, which claims the benefit of U.S. Provisional Application No. 63/271,538, filed 25 Oct. 2021, which claims the benefit of U.S. Provisional Application No. 63/272,653, filed 27 Oct. 2021, which claims the benefit of U.S. Provisional Application No. 63/318,126, filed 9 Mar. 2022, the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a simplified overview of end-to-end video processing flow in a video ecosystem.

FIG. 2 illustrates a full-reference video quality metric system diagram.

FIG. 3 is a flow diagram of an exemplary method for improving search experience for user expectations.

FIG. 4 is a flow diagram of a process for developing basic verification tests (“BVTs”).

FIG. 5 is a flow diagram of an exemplary workflow for improving search experience using BVTs. basic verification tests (“BVT”).

FIG. 6 is a chart for ambiguous BVT conditions.

FIG. 7 is a chart for a news feed system.

FIG. 8 is a system chart for using BVTs.

FIG. 9 is a flow diagram of an onboarding process for BVTs.

FIG. 10 is an illustration of an exemplary architecture for a server-side hosted environment for a cloud gaming system.

FIG. 11 is an illustration of an example server included in a cloud application platform that hosts an application in a server-side environment.

FIG. 12 is an illustration of an example server included in a cloud application platform that hosts an application in a server-side environment.

FIG. 13 is a flow diagram of an exemplary method for implementing hardware virtualization and simulation for server hosting.

FIG. 14 is a block diagram of an example system that includes modules for use in implementing a cloud gaming system in a server-side hosted environment.

FIG. 15 is a flow diagram of an exemplary method for filtering network traffic in a hosting environment.

FIG. 16 is a block diagram of an exemplary system for filtering network traffic in a hosting environment.

FIG. 17 is a block diagram of an exemplary user-mode application of an exemplary router for managing an exemplary kernel-level security filter.

FIG. 18 is a block diagram of an exemplary update to an exemplary security ruleset based on a change to an exemplary central service directory.

FIG. 19 is a block diagram of an exemplary router forwarding exemplary network traffic to an exemplary target location.

FIG. 20 is an illustration of an exemplary system for hosting an application in a server-side environment.

FIG. 21 is a flow diagram of an exemplary method for testing applications in a hosting environment.

FIG. 22 is a block diagram of an exemplary system for testing applications in a hosting environment.

FIG. 23 is a block diagram of an exemplary network for testing applications in a hosting environment.

FIG. 24 is a block diagram of an exemplary cloud-based application platform.

FIG. 25 is a flow diagram of an exemplary method for supporting multi-touch applications.

FIG. 26 is an illustration of supporting multi-touch applications via mirroring input.

FIG. 27 is an illustration of supporting multi-touch applications via rotational mirroring of input.

FIG. 28 is a flow diagram of an exemplary method for optimized graphics rendering.

FIG. 29 is an illustration of exemplary diagrams of a graphics pipeline with and without optimization.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Features from any of the embodiments described herein may be used in combination with one another in accordance with the general principles described herein. These and other embodiments, features, and advantages will be more fully understood upon reading the following detailed description in conjunction with the accompanying drawings and claims.

Example Systems and Methods for Monitoring and Improving End-to-End Video Quality Based on Scaled and/or Interpolated Perceptual Quality Scores Across Various Video Views

The present disclosure is generally directed to using Mean Opinion Score (MOS) metrics to measure and/or improve video quality at scale in video ecosystems. In some video ecosystems, a video collection may receive billions of views each day. Both the accuracy and the computational complexity of quality metrics may be equally important. The quality of uploaded user-generated content may vary widely. To compensate for such variations, certain metrics (such as MOSes) may consist of both a no-reference metric component to assess the original quality as well as a full-reference component to assess the quality preserved throughout the transcoding and/or delivery pipeline. Videos may be watched on a variety of devices (e.g., mobile devices, laptops, televisions, etc.) across varying network conditions. Moreover, such videos may be switched between in-line view and full-screen view during the same viewing session. Unfortunately, some traditional quality assessment technologies may fail to account for such variations in end-user devices, network conditions, and/or viewport resolutions.

The instant disclosure, therefore, identifies and addresses a need for additional apparatuses, systems, and methods for monitoring and improving end-to-end video quality based on scaled and/or interpolated perceptual quality scores across various video views. For example, these apparatuses, systems, and methods may account and/or compensate for variations in end-user devices, network conditions, and/or viewport resolutions while minimizing the computation overhead. As will be described in greater detail below, these apparatuses, systems, and methods may implement MOS metrics that facilitate end-to-end quality monitoring at scale as well as guide encoding and delivery optimizations. Some of these optimizations may be implemented in real-time quality measurements for live videos.

In some examples, these apparatuses, systems, and methods may account and/or compensate for the wide variation in popularity of videos across a streaming ecosystem. For example, less popular user-generated content may receive far fewer views than more popular professional content and/or viral user-generated content, which often receives upwards of millions of views. As will be described in greater detail below, the computational overhead of MOS metrics may scale with the popularity of videos. For example, more computing resources may be expended on more popular videos to obtain and/or deliver more accurate metrics, and less compute may be expended on less popular videos.

With the recent rise of the streaming media industry, video streaming has become one of the largest contributors to Internet traffic and/or bandwidth consumption worldwide. As a result, video streaming may present certain challenges. One challenge in video streaming has been delivering the best possible video quality to the user given the constraints of network bandwidth and the viewing device. In the context of the present disclosure, the term “video quality” may refer to the overall perceived quality of a video as expressed by a human subject who is watching the video on a certain display at a certain viewing distance. Moreover, video quality may be distinguished from artistic quality and/or production value. Accordingly, video quality may refer to a measurement of how well the content is presented, as opposed to a measurement of how good the content is.

Some techniques for measuring video quality may involve performing user-subjective testing (as in, e.g., the popular international standards ITU-R BT.5002). However, due to both privacy concerns and the scale of videos, additional techniques for measuring video quality with automation and/or without human intervention or observers may be needed. One challenge in measuring video quality has been scaling the video and/or monitoring the video for regressions in the processing pipeline.

The present disclosure focuses on measuring quality at scale in video ecosystems that consist of multiple video products. These products may span both video-on-demand and live video streaming. These products may include both professional and user-generated content. These videos may collectively receive billions of views each day, and this billion-view scale may inform and/or influence many of the choices in the video processing pipeline to minimize costs and/or energy use in data centers. As a result, computational efficiency may be a key consideration in video quality measurements at scale. Further, the present disclosure may describe how video quality metrics are able to account for the wide variation in ingested (e.g., uploaded) video quality and the diversity of viewing devices.

In some examples, mobile clients and/or browsers may upload videos across various video products. However, some video products may involve customized ingestion pipelines for specific curated content. The quality of uploaded and/or ingested videos may vary widely from one user to another. At one end of the spectrum, curated content and some user-generated content may be of very high quality (e.g., 1080p, 2K, 4K, ProRes, etc.) at very high bitrates. However, at the other end of the spectrum, much of the uploaded and/or ingested user-generated content may be of very low quality (e.g., resolutions of 360p and below) at very low bitrates (e.g., below 500 Kbps).

Various reasons for low upload and/or ingest quality may exist. For example, some videos may have effectively low bitrates due to being downloaded from other video products and then reuploaded into another streaming ecosystem. Other videos that originate from high quality sources may experience quality degradation as a result of transcoding on the client application prior to being uploaded to the streaming ecosystem. In some examples, client transcoding may improve and/or optimize upload reliability and/or minimize latency when videos are uploaded from poor connections (e.g. 2G, 3G, etc.). In live video uploads, the ingested quality may continue to vary as the client transcoding parameters adapt to changing network conditions.

In some examples, video products may support scenarios in which editing and/or remixing videos is made easy for the user before uploading. Such editing and/or remixing tools may support the addition of visual features (e.g., stickers, text, images, meme icons, and/or animation on top of video). Modified videos (such as meme videos) may start as low-quality sources with superimposed stickers and/or text. Unfortunately, traditional automated algorithms may have difficulty assessing the quality of such modified videos, as the quality of such modified videos is often conceived in the eye of the beholder. For example, some viewers may regard the perceptual quality (e.g., the sharpness) of stickers and/or text as much more important than the quality of the background video itself. Notwithstanding the difficulty of assessing such modified videos, the wide variation of upload quality may give rise to a need for an ingest quality metric to establish a baseline for quality and/or facilitate measuring the quality of the video from one end of the video pipeline to the other.

In some examples, the video pipeline may involve and/or perform certain processing steps on the original upload video to make that video available on viewer devices. For example, a video server may produce multiple encodings of the uploaded video at different bitrates and/or resolutions, thereby rendering the video in multiple quality representations. In this example, the video service may apply and/or perform compression on the video using standard video compression algorithms (e.g., codecs such as H.264, AVC, VP9, AV1, etc.). The segments produced for the different representations may be temporally aligned to facilitate bitstream switching at the client.

In some examples, when a user starts to watch a video, the user's device may fetch the manifest for this video. In such examples, the manifest may take into account the user's characteristics and/or preferences as well as his or her device's characteristics. In one example, the playback client running on the user's device may choose which of the multiple encodings to fetch at any given time based on both the network conditions and the device's capabilities. This basic approach to client-driven Adaptive Bitrate (ABR) streaming may be very popular and/or represent the de facto standard for several major streaming providers. In one example, to measure the quality preserved between the uploaded original and the encoding delivered to the client, a full-reference metric (such as structural similarity index and/or video multimethod assessment fusion) may be implemented.

In some examples, viewing devices and/or playback conditions may vary drastically across the viewing audience. For example, users may view streaming video content on mobile devices, laptops, desktops, tablets, and televisions—just to name a few. Such devices may have very different screen resolutions and/or rendering capabilities. Further, some mobile devices produced by the same manufacturer or vendor may vary widely in their resolutions and/or capabilities. Indeed, certain devices produced by the same manufacturer or vendor may lack decoding support for one or more VP9 and/or H.264 formats or profiles. ABR streaming may need to account for these variations in resolutions and/or capabilities across the collection of viewing devices.

In some examples, some video products may enable users to switch between in-line view and full-screen view, which causes a change in the effective playback resolution (also sometimes referred to as viewport resolution), during a single viewing session. For example, a user may start watching the video via the in-line view and then switch to the full-screen view. Unfortunately, traditional video quality assessment techniques may have difficulty accounting for this switch between the in-line view and the full-screen view because the perceived quality of the exact same encoding is dependent upon the viewport resolution.

In some examples, the quality of uploaded videos may be measured without the use of any references, especially when client transcoding is not involved. In such examples, the uploaded videos may be ingested in some compressed form, (e.g., H.264, AVC, etc.) which carries additional information (such as motion vectors) about the source and/or quantization parameter values for each frame and/or macroblock. Such information may be processed to improve the estimation of quality. Alternatively, the quality of uploaded videos may be measured with the use of only reduced references.

However, no-reference and/or reduced-reference video quality assessments may be challenging in video ecosystems. For example, imperfections like blurring may degrade the video quality, but such imperfections may be intentional (e.g., artistic license) and/or unintentional due to a poor source and/or poor network conditions. In this example, a traditional video quality assessment tool may be unable to distinguish between the intentional and unintentional cases using a pixel-domain no-reference metric. Similarly, some low-quality videos may have very high uploaded bitrates (possibly due to repeated transcoding). However, a traditional video quality assessment tool may have difficulty classifying such videos as low quality using a reduced reference metric.

In some examples, a video quality assessment tool may implement multiple algorithms, both no-reference algorithms and reduced-reference algorithms. In one example, the video quality assessment tool may compute a final upload quality metric score from a combination of individual scores. In this example, the video quality assessment tool may compute confidence signals on the upload quality metric based on similarities and/or commonalities among these individual scores.

In some examples, some video products and/or platforms may impose specific requirements for identifying and/or classifying high- or low-quality uploads. For example, some video products and/or platforms may require high confidence scores for identifying and/or classifying high quality uploads (for ranking and/or promotion). Additionally or alternatively, some video products and/or platforms may require high confidence scores for identifying and/or classifying in low quality uploads (for spam detection). These video products and/or platforms may use a combination of the individual quality scores and the confidence scores to satisfy those requirements.

In some examples, the playback quality metric may include and/or represent a full-reference metric component used to measure the quality preserved by the video processing pipeline between original upload and the encoding delivered to the viewing device. Examples of such full-reference metrics include, without limitation, Peak-Signal-to-Noise-Ratio (PSNR), Structural similarity index (SSIM), Video Multi-method Assessment Fusion (VMAF), combinations or variations of one or more of the same, and/or any other suitable full-reference metrics. According to certain subjective experiments, SSIM may have a higher correlation with subjective image quality than PSNR.

In some examples, SSIM may be efficiently introduced and/or implemented in video transcoding pipelines. Additionally or alternatively, VMAF may be able to use existing metrics, such as PSNR and SSIM, and fuse them to achieve accuracy that is higher than any individual metric. Of course, this higher accuracy may come at the cost of higher complexity. For example, VMAF may involve complexity and/or computation that is about 100 times higher than SSIM.

In some examples, MOS metrics may implement and/or involve SSIM as the core full-reference metric to assess quality preserved in the video processing pipeline. In one example, a video quality assessment tool may map SSIM scores, which are traditionally non-linear, to a linear scale of 0 to 100 introduced through subjective validation. In this example, the video quality assessment tool may selectively introduce and/or implement VMAF into the MOS metric for premium videos.

In some video ecosystems, a popular video may have millions of views, each coming from a different device with a different resolution. Some of these views may involve switching between the inline-view and the full-screen view during the same session. As a result, even if the same encoding were played for all these views (without, e.g., ABR switching), the perceptual quality score for each view may be different. The introduction of ABR switching on top of the varying device resolutions may further complicate the computation of quality metrics.

In some examples, a video quality assessment tool may be able to compute MOS metrics by accounting for the varying viewport resolutions and varying encodings played during the viewing sessions. To do so, the video quality assessment tool may compute a MOS metric at the encoding-side for each encoding at fixed viewports and then account and/or compensate for the viewing-side interpolation of MOS metrics and/or aggregation. For example, for each encoding in the ABR ladder, the video quality assessment tool may compute the full-reference metric for that encoding against the original upload at a set of fixed viewport resolutions. As a specific example, if the original upload is a 1080p source, a video encoder may produce a 360p encoding from that original upload as part of the ABR ladder. In this example, if the viewport resolutions used for MOS pre-computation are 480p and 720p, a video scaler may scale the original upload and the 360p encoding to 480p resolution. The video quality assessment tool may then compute and/or generate an SSIM score for the 480p resolution. Similarly, the video scaler may scale the original upload and the other encodings to 720p resolution, and the video quality assessment tool may then compute and/or generate an SSIM score for the 720p resolution.

In some examples, such scaling and computation processes may be repeated for each resolution in the fixed viewport list as well as each encoding in the ABR ladder. These scores may also be stored as metadata with the encodings. When this video is watched on a viewing device, a viewing client on the device may send information about the device's screen resolution to the video server. Additionally or alternatively, the viewing client on the device may send information about the moment in which the user switches from the inline-view to the full-screen view and/or information about the chosen encodings to the video server. As a specific example, if the first 60 seconds of playback involved a 360p encoding being viewed at full screen (corresponding to a 540p viewport), the video quality assessment tool may use the pre-computed SSIM scores for this encoding at the closest fixed viewports and then interpolate to compute the SSIM score at the actual viewport. The video quality assessment tool may then map the SSIM score to the linear 0-100 scale.

This process of MOS interpolation may be performed for any time segment involving a change in the encoding played or the viewport resolution. By using such MOS interpolation, the video quality assessment tool may compute a more accurate quality score for such segments. The video quality assessment tool may be able to compute the quality score of each segment independently of one another and/or without any dependency on other segments. Additionally or alternatively, the video quality assessment tool may be able to aggregate the quality scores for each segment to facilitate computing the overall quality score for the entire viewing session (by, e.g., arithmetic or harmonic averaging and/or by computing other statistics).

As will be described in greater detail below, the video quality assessment tool may be able to use the MOS scores to compute end-to-end quality for monitoring purposes and/or to drive quality improvements. In addition to using the MOS scores of each view to identify certain quality issues, the video quality assessment tool may aggregate the MOS scores across various dimensions and/or parameters (such as the viewing client, the video product, and/or the upload score). In one example, any change in the aggregate MOS score may indicate and/or provide an early signal into regressions across the entire video processing pipeline.

As a specific example, a change in the no-reference upload MOS metric may indicate and/or suggest a change in the ingestion section of the pipeline (such as a drop in the number of 1080p or 720p uploads). The majority of user-generated uploads may originate from mobile devices, which often perform transcoding on the video content prior to upload. As a result, regressions in the upload MOS metric may be indicative and/or suggestive of regressions in the upload video quality.

In some examples, changes in the full-reference MOS metric may indicate and/or suggest regressions in compression efficiency or even more subtle changes in the interaction between the specific lanes being generated and served, the available network bandwidth, and/or the viewing client's ABR decisions. For monitoring purposes, the video quality assessment tool may monitor and/or consider the overall watch-time weighted MOS metric as well as the distribution across specific quality thresholds.

In some examples, the video quality assessment tool may use full-reference MOS metrics to track improvements in compression efficiency by using advanced codecs (such as AV1) or better encoding recipes (such as dynamic optimizer and longer GOPs). The video quality assessment tool may also use full-reference MOS metrics to track improvements in the ABR client due to better bandwidth estimations and/or network protocols.

Videos uploaded to the streaming ecosystem may vary widely in the amount of watch time they receive. The variance in watch time may be attributed to a number of video characteristics, including the product type, the popularity of the uploader, and/or the video content. In some examples, a small percentage of the uploads may receive the majority of the watch time. The video quality assessment tool may take advantage of this knowledge by producing encodings with higher compression efficiency (at a higher computational cost) for videos with a high predicted watch time. The CPU cost of x264 encodings at the “slow” preset may be about four (4) times as much as the CPU cost of x264 encodings at the “very-fast” preset, while the compression efficiency of x264 encodings may be approximately twenty (20) percent higher. Similarly, the VP9 encodings may have approximately six (6) times higher CPU complexity as compared to the H.264 encodings at the “slow” preset while also having higher compression efficiency. The video quality assessment tool may use this knowledge to make per-video decisions on compute versus egress based on the predicted popularity.

To take advantage of the varying computational efficiency and compression efficiency, the video quality assessment tool may implement several ABR families. Examples of such ABR families include, without limitation, basic ABR, full ABR, VP9, variations or combinations of one or more of the same, and/or any other suitable ABR families. In one example, basic ABR encodings may include and/or represent those produced with the H.264 codec “very-fast” preset and a relatively smaller number of lanes. Basic ABR encodings may often be produced for all videos.

In one example, full ABR encodings may include and/or represent those produced with the H.264 codec “slow” preset and a higher number of lanes per video. Full ABR encodings may be produced either if the video or product is of higher importance or when the watch-time of the video is above a certain threshold. Full ABR may be available for delivery of around ninety-nine (99) percent of video watch-time.

In one example, VP9 encoding may include and/or represent those produced with the VP9 codec typically at the slowest preset for most lanes. VP9 encodings may be produced for the most important content and the content with the highest watch-time. While VP9 encodings may be produced for less than one (1) percent of videos, VP9 coverage may be available for around fifty (50) percent of watch-time.

In some examples, the video quality assessment tool may use MOS metrics to measure the performance of each of these families from the standpoint of delivered video quality. The video quality assessment tool may track the performance of each family (in terms of, e.g., watch-time weighted mean MOS metric) over time to determine both short term (e.g., week over week) regressions and long term (e.g., month over month) regressions in a particular family. The families may be compared with one another to ensure that the more computationally expensive families continue to provide the expected benefit over their cheaper counterparts.

In some examples, the video quality assessment tool may measure and/or compare the overall performance of the video ecosystem and/or pipeline across all ABR families. If the performance of individual families and their relative performance to one another has not changed, the video quality assessment tool may determine that a change in the overall delivered video quality indicates and/or suggests a resource shift that is causing the delivery of less advanced encodings. For example, an increase in video uploads may reduce the available capacity for generating VP9 encodings. Additionally or alternatively, a drop in VP9 coverage may decrease the overall MOS metric of the video ecosystem and/or pipeline.

In some examples, if ABR encoding production remains the same, then regressions in the MOS metric may indicate and/or suggest regressions in delivery time decisions about which encodings to serve and/or regressions in client-side playback performance. In order to isolate these effects, the video quality assessment tool may compare the MOS metric over time by client application and/or specific application version. In one example, a regression that only affects a specific mobile application version may be caused by a client-side change, whereas a regression in delivered quality that affects all versions of a device platform may be caused by a delivery configuration and/or pipeline problem.

In addition to end-to-end monitoring, the video quality assessment tool may use MOS metrics to optimize encoding and/or delivery decisions. Video quality may not always offer a linear increase in benefits to the viewer. For example, as quality increases by a certain degree, the amount of enjoyment experienced by the user may fail to increase by the same degree. Accordingly, the video quality assessment tool may institute and/or implement certain thresholds (such as quality perceived as “unacceptable” versus “acceptable” and/or “annoying” versus “non-annoying”). On the one hand, the video quality assessment tool may expect users to simply stop watching a certain video when its quality drops below a certain threshold. On the other hand, the video quality assessment tool may assume that the perceived video quality does not change much after exceeding another threshold. By focusing on these thresholds, the video quality assessment tool may be able to guide encoding and/or delivery decisions or improvements.

In some examples, by reducing the number of sessions with bad video quality based on the MOS metric, the video quality assessment tool may be able to perform and/or achieve a variety of optimizations, such as increased Group of Picture (GOP) sizes, optimized resolutions at the low end of the ABR ladder, and/or optimized compute resource allocation across the lanes. Additionally or alternatively, by using slower presets for the lowest lanes, the video quality assessment tool may produce and/or produce small increases in compression efficiency, which in turn translate into larger reductions in the number of sessions with unacceptable quality. In doing so, the video quality assessment tool may incur a loss of one (1) or two (2) percent of compression efficiency at 1080p, but such loss may have no meaningful effect on the number of sessions with acceptable video quality.

For delivery and playback monitoring, the video quality assessment tool may be able to leverage MOS data to determine which video qualities to play in specific situations. Without any constraints, the player running on the viewing device may choose to play the highest available quality. However, due to imperfect bandwidth estimates, the player may need to determine an acceptable level of risk when making ABR decisions. By taking MOS metrics into consideration, the player may assess whether the increase in quality would offset the risk of playing a higher lane. This assessment may allow and/or enable the player to be more aggressive when increasing quality across certain thresholds and/or less aggressive when increasing quality despite a higher risk of stalls.

In certain examples, the video quality assessment tool may need to conserve data usage and/or keep bitrates lower than the user's available bandwidth might support. For example, mobile data connections may need to be mindful of total data usage (to avoid rapidly consuming a user's available data). In other cases, the video quality assessment tool may need to reduce the total amount of egress due to Internet service providers' capacity constraints, such as the recent pandemic-related data caps. In other cases, the video quality assessment tool may consider and/or take into account certain regional capacity constraints due to fiber cuts or loss of Content Delivery Network (CDN) capacity.

In some examples, the video quality assessment tool may need to limit which qualities are played and/or optimize the delivered quality per byte consumed. In one example, the video quality assessment tool may limit resolutions (by, e.g., restricting playback to standard definition) or reduce bitrates (by, e.g., restricting playback to 1 Mbps). However, due to variations in the nature of the content, the video quality assessment tool may be unable to control bitrate and resolution constraints over the resulting quality distribution, thereby risking an increase in the number of sessions with annoying and/or unacceptable quality.

Accordingly, the video quality assessment tool may directly leverage MOS metrics to make delivery decisions, as opposed to simply relying on resolution and/or bitrate information. By doing so, the video quality assessment tool may be able to create and/or facilitate a more consistent experience, thereby allowing higher bitrates for complex content and/or enforcing lower bitrates for simple content in order to achieve comparable byte savings with a better overall experience.

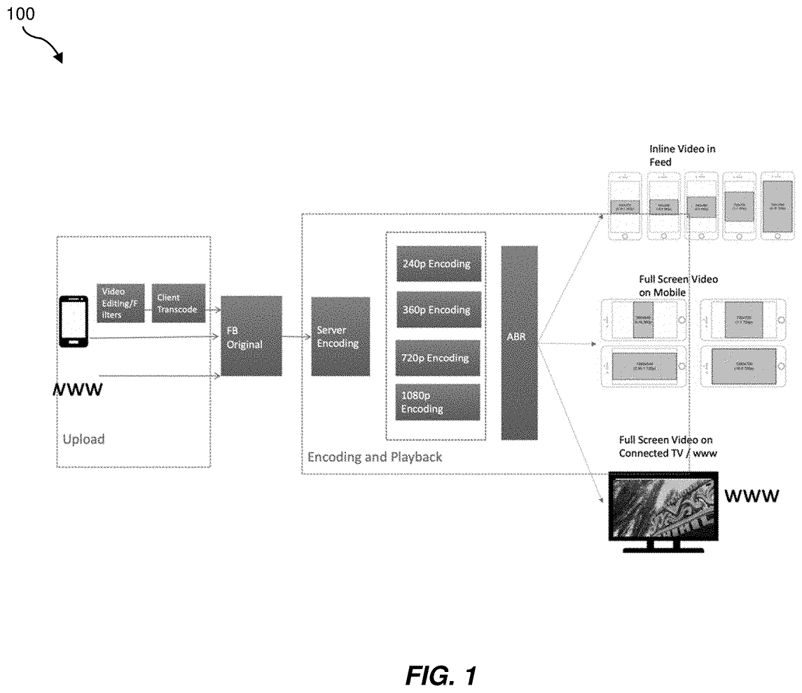

An overview of the end-to-end video processing flow is shown in diagram 100 in FIG. 1 which may comprise two major components: (a) Upload (Ingestion) video by a publisher/user, which may be referred to as the original; and (b) Encoding into multiple qualities (resolutions) and ABR delivery for video playback on viewing devices. This encoding is performed using standard video compression algorithms (codecs) such as H.264/AVC, VP9 and AV1.

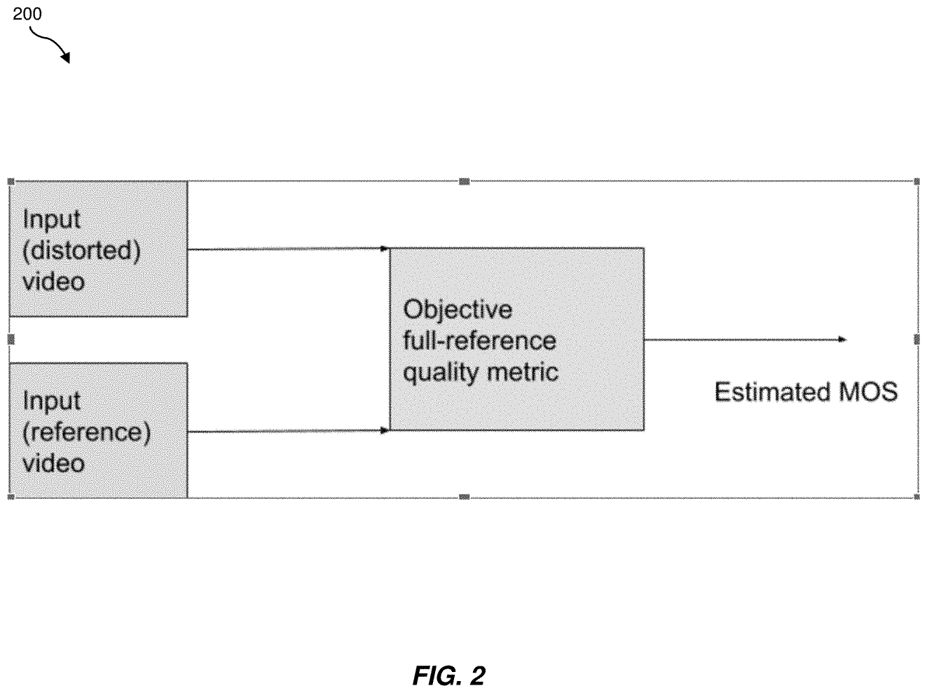

FIG. 2 shows a diagram 200 illustrating that the distorted video is the result of encoding (and optionally scaling) an input source video.

### Example Systems and Methods for Improving Search Experience for User Expectations

Traditional search engines typically perform Internet searches for web content that matches user queries. However, certain platforms, such as a social networking service, may require a specialized search engine for searching content on the platform. Unlike traditional search engines, such a specialized search engine may exhibit infrequent search traffic and may often include highly personalized cases.

Unfortunately, traditional search engine algorithms may not produce the desired results if applied to a specialized platform, such as a social networking service. The same query may have different meanings or expectations for different users. For example, a name on a social networking service may refer to a friend's name, a followed page name, a joined group name, a recent post title, etc. Traditional search engines may not be able to ascertain the user's expectations and may therefore struggle with producing and returning relevant results.

The present disclosure is generally directed to improving a search experience on a specialized platform, such as a social networking platform or service. As will be explained in greater detail below, embodiments of the present disclosure may classify a query into categories, identify a user expectation based on the categories, and rank corresponding search results based on the user expectation. The systems and methods described herein may utilize a divide-and-conquer approach to improving search. Queries may be categorized into different query patterns corresponding to different intents or expectations (e.g., people, pages, news, commerce, etc.). The expectation for each query pattern may be tested using a basic verification test (BVT) corresponding to each query pattern. Each search query may be processed through testing patterns to determine which query pattern fits best. The corresponding BVT may compute a success rate, the results of which may be used for fine tuning the query patterns.

Features from any of the embodiments described herein may be used in combination with one another in accordance with the general principles described herein. These and other embodiments, features, and advantages will be more fully understood upon reading the following detailed description in conjunction with the accompanying drawings and claims.

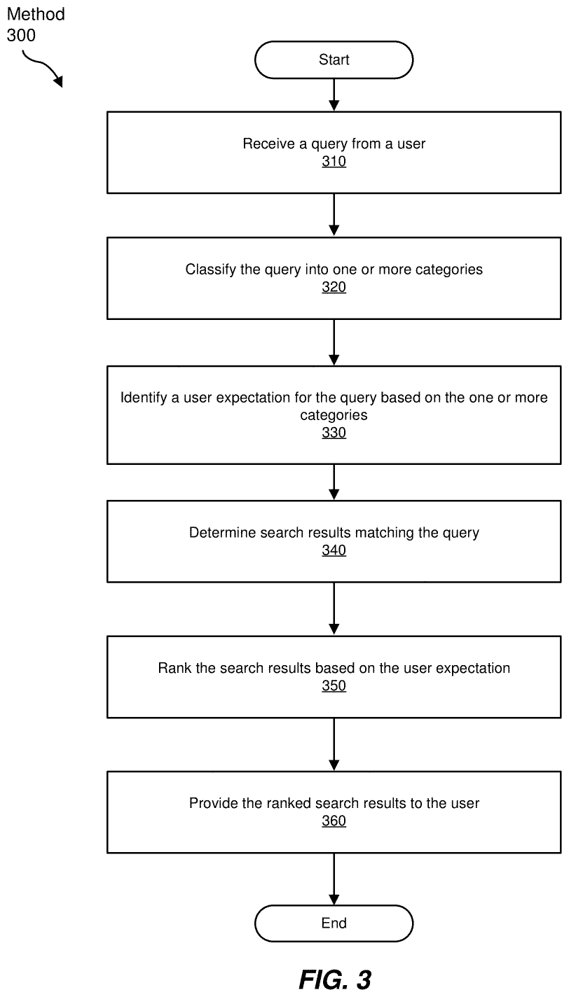

FIG. 3 is a flow diagram of an exemplary computer-implemented method 300 for improving search experience for user expectations. The steps shown in FIG. 3 may be performed by any suitable computer-executable code and/or computing system. In one example, each of the steps shown in FIG. 3 may represent an algorithm whose structure includes and/or is represented by multiple sub-steps, examples of which will be provided in greater detail below.

As illustrated in FIG. 3, at step 310 one or more of the systems described herein may receive a query from a user. In some embodiments, the term “query” may refer to a piece of information that a user may wish to find related content. Examples of queries include, without limitation, text-based queries, links, images, videos, etc.

The systems described herein may perform step 310 in a variety of ways. In one example, a user may input a query into a search field on a platform such as a social networking service. In other examples, the user may select a link or other user interface widget that may input the query.

At step 320 one or more of the systems described herein may classify the query into one or more categories. The categories may be relevant to the platform such as the social networking service. Examples of categories may include, without limitation, people, pages, groups, events, local business, product/commerce, news, sports, entertainment, hashtags, election, COVID-19, direct navigation, photos, miscellaneous, other topics, etc.

The systems described herein may perform step 320 in a variety of ways. In one example, classifying the query may further include classifying, using one or more machine-learning classifiers, the query into the one or more categories. In some examples, classifying the query may be based on at least one of a social graph of the user, or a previous search history of the user. In some examples, the query may be matched to one or more query patterns that may be associated to categories.

At step 330 one or more of the systems described herein may identify a user expectation for the query based on the one or more categories. In some embodiments, the term “user expectation” may refer to a context for the user's query, which may also relate to the user's intent for the query. The user expectation may also relate to one or more categories. For example, if the user types in a friend's name, the user may intend to find a person connected to the user's social graph. A query containing a person's name may be classified into the “people” category, which may reflect the user's intent to find a person.

The systems described herein may perform step 330 in a variety of ways. In one example, the systems may log results for further analysis. For instance, step 330 may further include logging the query, the user, and the user expectation. In some examples, identifying the user expectation may be based on success data from at least one basic verification test (BVT) testing previously logged users, queries, and user expectations.

At step 340 one or more of the systems described herein may determine search results matching the query. Examples of search results may include, without limitation, links, images, posts, pages, persons, groups, events, and/or other content available on the platform.

The systems described herein may perform step 340 in a variety of ways. In one example, the query may be processed for each of the classified one or more categories such that the search results may include content matches from the one or more categories.

At step 350 one or more of the systems described herein may rank the search results based on the user expectation. The systems described herein may perform step 350 in a variety of ways. In one example, the search results, which may be ranked by relevance within each category, may be maintained as separate search result lists for each category. In some examples, the search results from the one or more categories may be weighted based on how strong the query corresponds to the category and combined into a single search result list.

At step 360 one or more of the systems described herein may provide the ranked search results to the user. The systems described herein may perform step 360 in a variety of ways. In one example, the search results may be presented as a list of results that the user may navigate. In some examples, the search results may be dynamically presented, such as an auto-complete field, suggestions, etc.

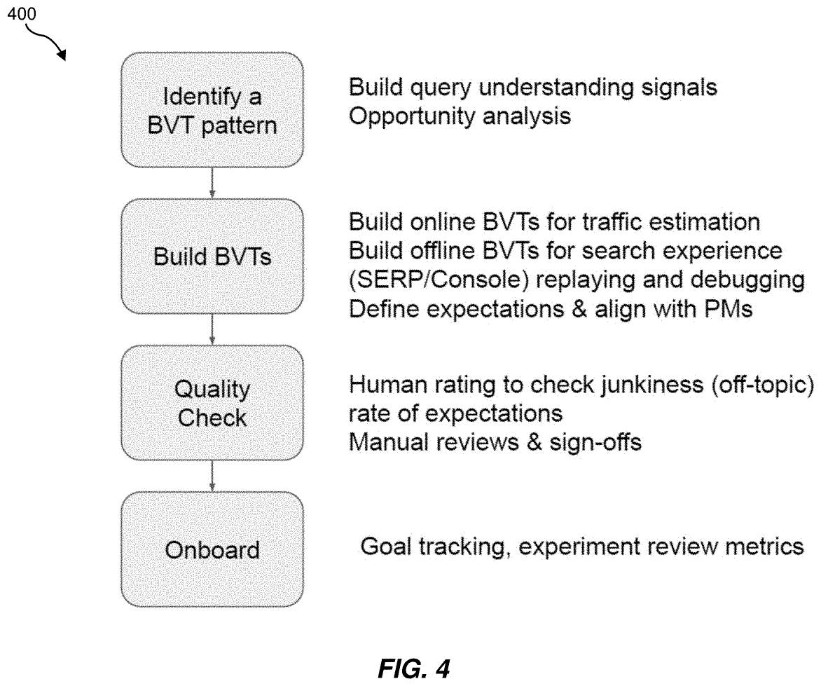

FIG. 4 illustrates a chart 400 for developing BVTs. Developing BVTs may include, for example, identifying a BVT pattern, building BVTs, quality checks, and onboarding.

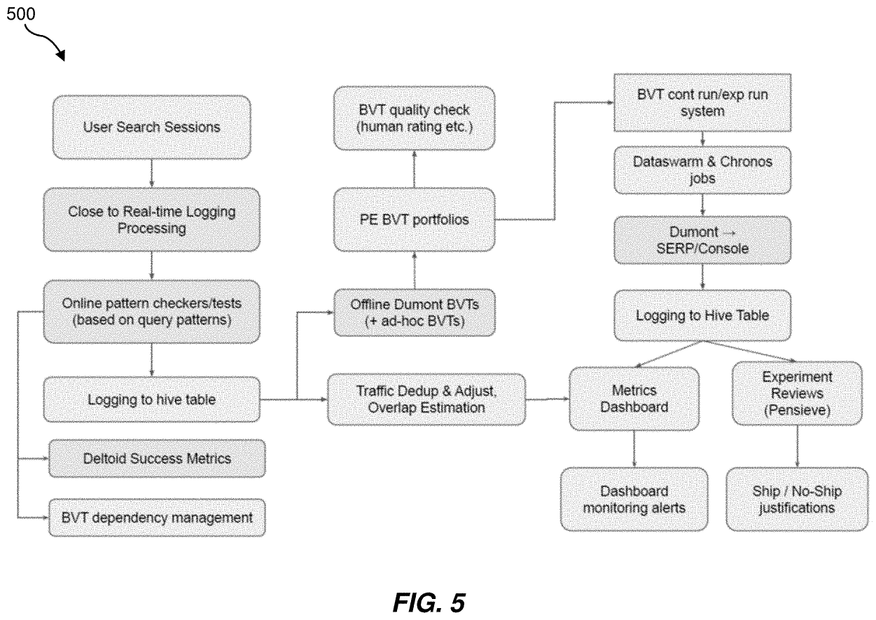

FIG. 5 illustrates a flow chart 500 for product expectation (“PE”) BVT system workflows.

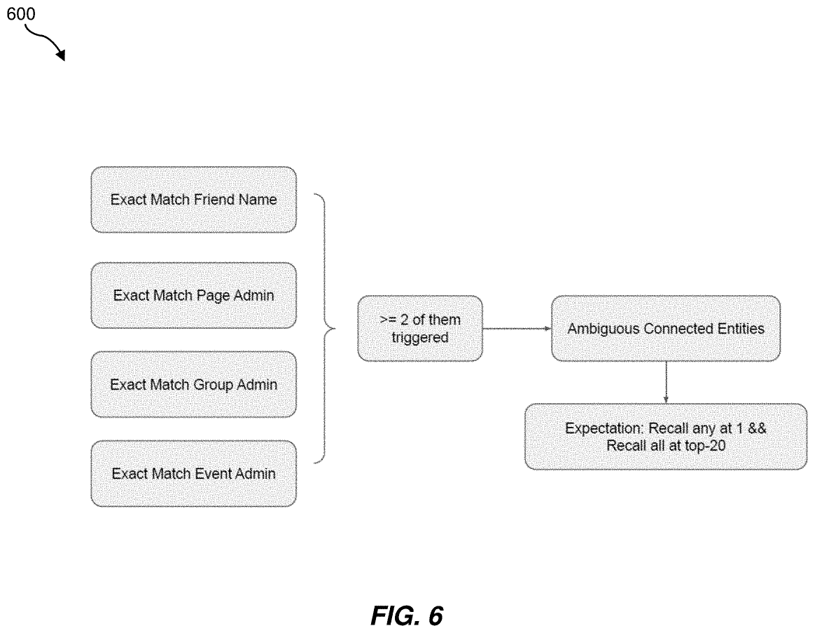

FIG. 6 illustrates a chart 600 for ambiguous cases when more than one BVT (e.g., query pattern, category) may apply to a given query. For example, if two or more of “exact match friend name,” “exact match page admin,” “exact match group admin,” and “exact match event admin” are triggered, the ambiguous connected entities may be resolve by setting the expectation as any category if looking at one result, or all triggered categories if looking at, for instance, the top 20 results.

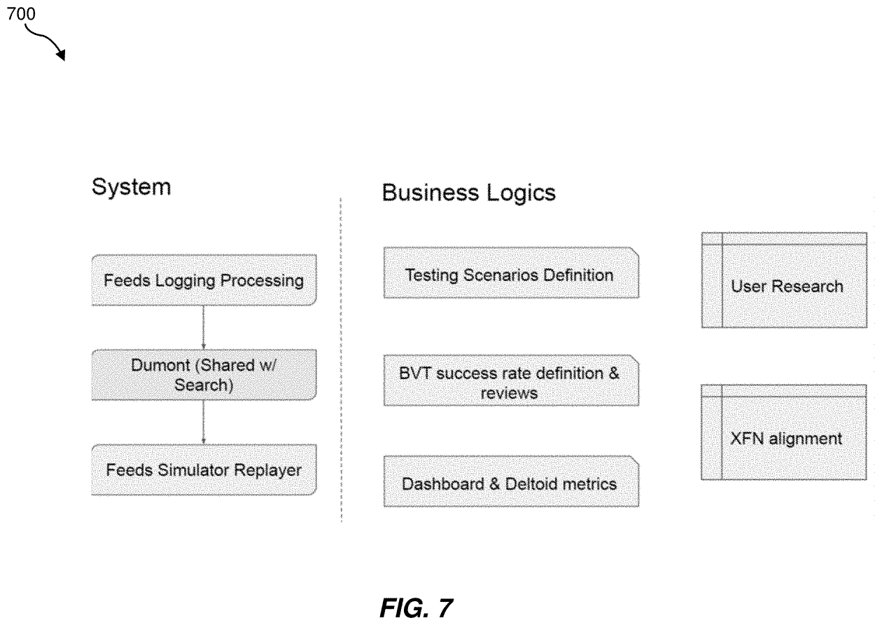

FIG. 7 illustrates a chart 700 for applying PE BVTs to a news feed ranking for a social networking service, for example by applying a divide-and-conquer approach to search/recommendation.

To improve the relevance of the search experience, a quality-level based framework may be used, to improve specific use-cases and address user problems. A basic product expectation (“PE”) quality foundation may be built by taking a divide-and-conquer approach to address complex and ambiguous search quality problems.

Context About Search Quality

Some social networking services total around two billion daily search queries globally. Search presents a challenging quality problem because a user's encounter with a less than satisfactory set of results can contribute to a negative perception of quality. To make the problem even more difficult, as opposed to traditional web searches or general search engines, most of such search traffic is infrequent and includes highly personalized cases. The same search query (e.g., {david}, {maria}) may have different meanings for different users (e.g., can be their friend's name, followed page name, joined group name, their recent post title, etc.).

From a recent search success survey, users reported that the top pain points of search are related to relevance/quality, speed/performance, and integrity. In order to address these fundamental relevance/quality pain points, many internal metrics (e.g., user click rate, human rating relevance, integrity, speed, etc.) were developed to measure the success of a search trial. Additional problems for different query intents (e.g., intent grid), selected use cases (News/Sports/Entertainment use cases), etc. were also addressed. A divide-and-conquer framework is described herein which may easily help to track and improve search quality in a deliberate fashion.

Systematic Improvement to Search Quality

As described herein, user surveys were leveraged to help find the intent from real users. The intents were broken into different query patterns to build the product expectations for each pattern. With the help of logging processing and basic verification tests (“BVT”), the query traffic (coverage) and success rate of each pattern may be measured. This baseline may allow focusing on cases where the query traffic is non-trivial, but success rate may not yet be optimal. This new framework may help to answer the question of how good the search quality is and identify where there are key issues and opportunities.

Product Expectation Basic Verification Test (PE BVT)

Although it may be difficult to describe what quality means to an end user, it may be relatively easy to ask the question, “when you are searching with this query, what do you expect to see?” An instance of product expectation for a search may be described by a combination of (query, user, expectation) information. There may be millions or billions of such expectations among all social network users. Here, the query is usually a piece of text string, the user may be all possible information about the searcher, and the expectation may be either some deterministic ID, or special types of results, etc. For example: {query=David Brown, user=a user with a friend named David Brown, expectation=give me the friend profile}; {query=Mary Smith, user=a random user, expectation=show me the official page of Mary Smith}; {query=songs, user=a user that loves to listen to music, expectation=show me a list of popular music videos}.

A basic verification test (BVT) may be a method to help define such (query, user, expectation) combinations as a “unit-test” for a specialized search engine and to check if the search results match the expectation. A PE BVT may report success if the results match expectation or report failure otherwise. A PE BVT may be flexible in breaking down real search traffic and may be scalable to possibly address most search patterns.

Query Pattern Based Product Expectations

It may be difficult to extract detailed (query, user, expectation) examples from taxonomies. Although users may know that they want to “verify or confirm information” when their intent is to search for people, it may be hard to use such information to extract which particular piece of information they want to verify. It may also be difficult for search ranking engineers to execute on such abstract definitions.

Therefore, the present application discloses a detailed query-pattern based expectation with more detailed information, adopted from high-level categories. A detailed system design is described herein.

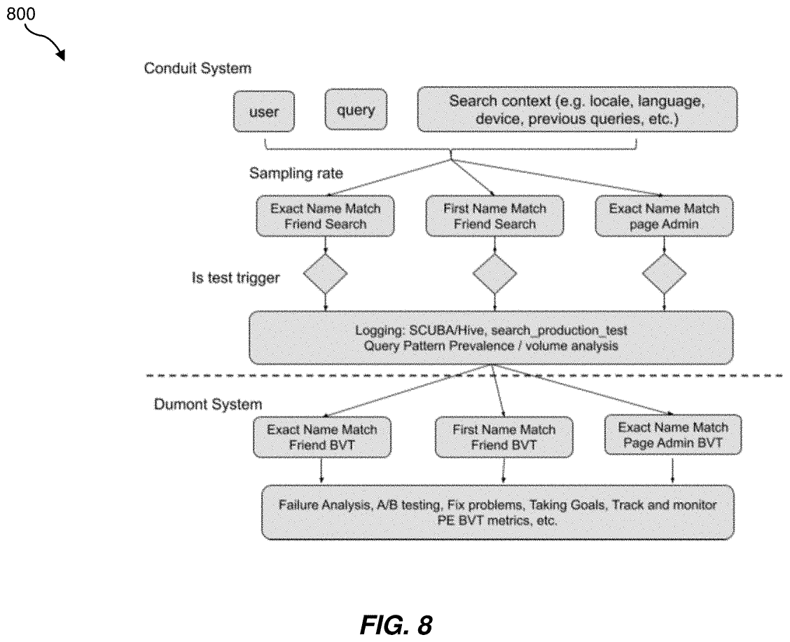

This query-pattern based product expectation system may have two parts: (1) a real-time logging process part where, for every single search session, queries may be processed through all testing patterns to see which pattern a session will fall into, such information may be logged as a (query, user, expectation) example, and the traffic/coverage of each pattern may be estimated; (2) an offline BVT construction and success rate computation, which may leverage the output of (1) to compute the success rate. FIG. 8 illustrates a diagram 800 of a product expectation system with two parts as described herein.

By observing user engagement improvements from multiple experiments and launching when the success rate of BVTs is improved, there may be numerous engagement and success rate wins among many BVT patterns. Below are selected examples from a diverse set of query patterns.

People pattern: the IEM model improvements may have gained 0.05% of sequence quality click rate (SQCR) and 1.2% of connected first name BVT wins. Rejection rules tuning may have brought 5% success rate increase in unconnected people scenario.

Page pattern: the recent visited pages boosting may have gained 0.18% session page click rate with approximately 3% more recently visited pages BVT wins. Exact connected pages boosting may have brought 0.22% page click gain with a 0.3% success rate increase in an unconnected page BVT.

Celebrity: adding non-social media celebrities as InfoBox (which may increase the BVT from 64% to 90%, increase page downstream action by 1.8%, and increase InfoBox click wins by 328%), as well as enabling image rendering in KG info box, and suppressing user modules for socially unconnected users may provide gains. For celebrities, the boosting logic for blue verified exact matches for sensitive queries may be adjusted, which may improve the featured post results and public post results. In addition, suppression of IEM user results may be refined using social signals and the recency of the results (which may have gained approximately 4% newsy celebrity BVT wins and 7.8% featured).

Commerce: the commerce module boosting for commerce intent queries may have gained approximately 1.7% MLI while improving car BVTs from less than 10% to approximately 40%.

Videos keywords: the boosting of videos for videos intent queries may have gained approximately 2.3% live video time spent while bumping the success rate of live videos BVT from 52% to 90.8%.

News: by migrating NES into NLP service and enabling it for 3 additional locales, news traffic coverage may have improved by 0.2%. Improving the news ranking model may have resulted in +68% share clicks of search sequence quality clicks, and +77% search referred value clicks on share, with an approximately 2.1% increase in global news BVT wins. By also demoting other modules when there are strong news intents, approximately 8% global news BVT wins and approximately 2% news daily participated users on search with news intent may be gained.

Typeahead: Typeahead may be an important entry point to direct good traffic to a search engine results page (“SERP”), and Structured Typeahead may also help provide more context information to help improve success rate. With all the great launches from Typeahead quality and Structured Typeahead, an Entry Points Holdout has shown that Typeahead may have increased the BVT traffic coverage by +1.2% (vs. Search Holdout+4.7%) and may have increased the success rate by +0.5% (vs. Search Holdout+3.6%).

BVT Dependencies and Overlaps

One user search session may possibly be classified into several query pattern based BVTs. For example, when a user is searching for a common name such as “David Zhang,” the query may refer to the user's friend or friend of friend. When a user is searching for a term such as “Washington,” the query may refer to the US president's last name or a last name of the user's friend.

To address such problems, a method named “BVT dependencies” may be used to break the tie and assign the search session to the most likely query pattern from available product expectations. One BVT may have multiple dependencies, and once its dependency is triggered, the current BVT may not proceed.

Even with such a BVT dependency approach, there may still be possible overlap. For example, a query “Mary Smith” may either refer to a celebrity search pattern or a global-news pattern if there is recent news about her. Such overlap may create difficulty in accurately estimating the BVT coverage and success rate. Several methods described herein may ease the problem by estimating overlapping traffic and subtracting it from the coverage.

BVT Qualities

Since BVTs may be viewed as pre-defined rules, it may be difficult to achieve 100% accuracy. Therefore, a BVT quality dashboard may be used to measure BVT quality and stability. BVT quality may be viewed as a metric for a metric, since BVT quality may measure the BVT, while the BVT may measure the search quality.

Human rating may be used to evaluate the BVT expectations. Example (query, user, expected ID) entries may be prepared, and human raters may check if they are indeed relevant using search relevance guidelines. Such ratings may report some statistics, which BVT developers may use to improve the BVT quality.

Alternatively or in addition, A/A tests—where both a control and a test have the same settings—and A/B tests—where a control and a test are very different—may be used to check if BVTs are having stable results in A/A and significant changes in A/B. Once a BVT is easily changed using an A/A test, there may be certain system noise or instability. Such noise or instability may identify which BVTs may require double checking and/or fixing.

BVT Archetypes and Development Methods

There may be different types of BVTs based on how we define the success rate:

Expected-ID: the exact ID needs to be returned as the top results for the search. In some embodiments this may cover approximately 50% of BVTs.

Expected result type: a certain type of results (e.g., photo, video, post, pages) may be required. In some embodiments this may cover approximately 10% of BVTs.

Expected result feature distribution: certain feature distributions of the top results (e.g., fresh results at top, nearby results at top) may be requested. In some embodiments this may cover approximately 5% of BVTs.

Expected result-set distribution: different from expect single result, result-set distribution may refer to an expectation, among all search results, of certain behaviors (e.g., diversity, language mismatch, etc.) or certain conditions (e.g., counter intuitive BVTs). In some embodiments, this may potentially cover all query traffic through addressing the horizontal problems.

In order to accelerate the development of BVTs, various problems and several different types of methodologies to address the same are further described herein:

Single token and template rules: There may be lots of ambiguous single token queries and rules that may be developed to cover more queries.

Typeahead: as entry-point of search, typeahead may play an important role to improve the success of search by recommending success query patterns and by reducing the potential of difficult queries (e.g., typos, complex queries, etc.).

Doc-driven approach: it may be difficult to extract patterns for unconnected cases if only the user social graph is checked. To address this issue, several document-based laser look-up tables may help link a query with unconnected entities (e.g., users, pages, etc.).

Multiple expect-IDs: there are certain cases where an expected-ID may not be unique (e.g., users may have multiple friends with same name). Such cases may require special understanding.

Tab search: tab search, comparing with main SERP, may have non-trivial query traffic (e.g., people tab may be approximately 5%, posts tab may be approximately 1%, etc.). In order to have a good experience for tab search, main (top) SERP BVTs may be leveraged to measure the performance of a tab search.

Blind-set: in order to avoid unconscious bias from engineers who are developing and improving BVTs, a blind set that is mainly used for evaluation purposes may be implemented. In principle, engineers may only use a development set for failure-analysis and system improvement while blind sets are completely mutually exclusive to avoid overfitting.

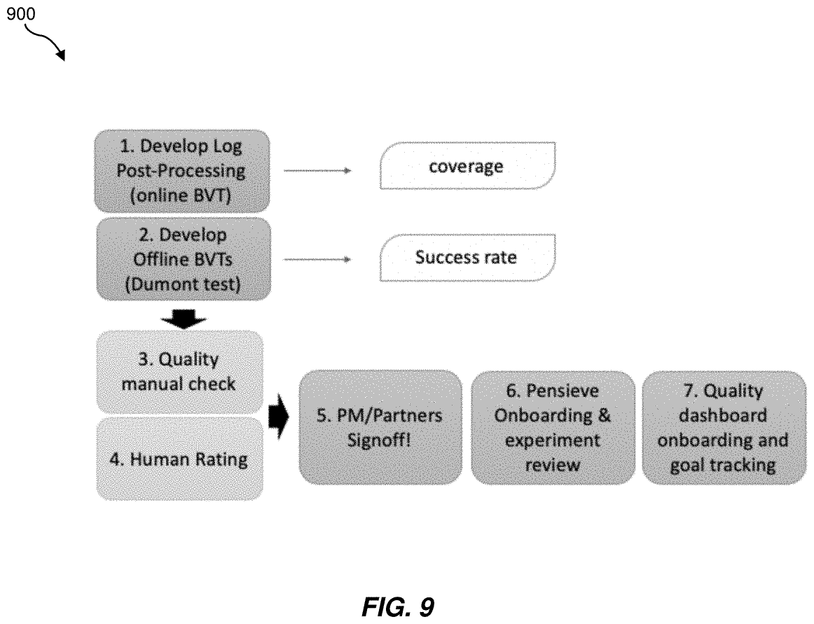

FIG. 9 illustrates a flow diagram 900 of onboarding BVTs. In some examples, an onboarding process may include: 1) developing a log for post-processing; 2) developing offline BVTs; 3) quality checks; 4) human rating; 5) signoff; 6) experimenting and review; and 7) quality dashboard onboarding and goal tracking.

Improving the BVT Success Rate

While improving query understanding may contribute to BVT coverage improvement, improving BVT success rate may be more challenging. After analyzing for the upper bound of a BVT success rate estimate, certain challenges that may prevent a 100% BVT success rate have been identified, as follows.

Success rate definition dilemma: BVTs may have a metric such as recall_at_1_above_similar. The expanded definition may be, “I want to have this ID returned as top-1, or things above it should have similar quality.” However, it may be difficult to define this “above-similar.” Relaxing the BVT success rate definition may result in a high success rate, but poor SERP quality. However, it may still be desirable to include cases where recall_at_1 fails but the SERP quality is good. Above-similar may be defined as an exact match with a connected or verified entity. There may be other issues as well, such as not including content that is posted from such entities or missing certain opportunities to return unconnected or nonverified cases.

Precision/Recall of query pattern detection: There can be both false positive and false negative cases of a BVT query pattern. While false negative cases may hurt the recall of such a BVT, false positive cases may hurt the precision of the BVT. For example, if a news classifier has its precision as 80%, that might indicate at most an 80% success rate since the rest of the 20% of mis-triggered cases may not expect to see fresh content. In real scenarios, it may be even more complex since some of these cases may still see fresh but irrelevant content, but the BVT may treat them as success cases.

BVT dependencies & ambiguity: As explained above, one query may be ambiguous and potentially classified into multiple BVT patterns. Such cases may be allowed in order to maximize the concurrency of BVT developments. However, such cases may reduce the success rate since it may be difficult to have both BVTs be successful because the BVTs may expect different results ranked at the top of the SERP. Building and designing more BVT dependencies may ease these issues.

System dependencies: the system that computes the success rate may have certain issues including scraping instability, signal accuracy, BVT set up issues, and client-side inconsistency. For example, if the same query is issued with the exact same setting twice into the search engine, 1.6% of the time, the top-1 results may be different. This discrepancy may be due to issues such as real-time signal difference, query understanding signal difference, request time-out, etc.

Polished Experiences and Horizontal Problems Beyond Basic Quality

Since the PE BVT approach is generally directed to top results ranking quality/accuracy about a query, its effectiveness may be limited because: 1) users may have long-tail needs that cannot be covered by top results (e.g., when a user searches for “Minneapolis” and expects to see the latest protest news or other current events); and 2) users may have an exploration intent where they may want to explore more on the search results page (e.g., when a user searches for “new songs” and hopes to see a list of new songs).

To develop a higher quality, well-crafted end-to-end search experience, certain query segments may be improved to show a more polished experience. Experimentation with post-tab and celebrity segments as initial tests have shown improvements to relevance as well as updates to the overall user interface (“UI”).

Such polished experiences may help us refine and improve the basic quality definition. Based on insights from the development process, the system may have approximately 10 fundamental horizontal problems such as text relevance, freshness, popularity/engagement, social relevance, location relevance, etc. In order to deliver polished SERP experiences, such problems are further addressed herein.

Divide-and-Conquer Testing Framework

PE BVT may be an excellent framework to help divide-and-conquer problems.

As discussed herein, this framework may be leveraged for the purpose of ranking quality. However, this initial focus may limit the capability of this framework. For example:

Some BVT query patterns may have slower speed than others. Certain PE BVTs may be leveraged to improve general speed of search.

Some BVT query patterns may consume more CPU than others. Further analysis on the needs of such query patterns may save capacity.

Some BVT query patterns may have a higher success rate than others. Certain entry points (e.g., typeahead, related search, recommendation, etc.) may be leveraged to up-rank the entry points or show the entry points more frequently.

Additional Considerations for PE BVTs

Product Expectation (“PE”) BVTs may be generated from offline pipelines through document-oriented ways. For example, a Dataswarm pipeline may be used to generate possible <query, user-id, expected-doc> lists and develop Dumont BVTs based on the same. Certain conditions may hinder sustainable progress in a level-based metrics framework, as described below.

Lack of prevalence: All existing PE BVTs may be given equal weight and there is no query volume estimation for the same. For example, even if a given dashboard of PE BVT is 87%, this may not necessarily correspond to 87% of queries successfully meeting expectations.

Lack of user-generated queries: A large portion of queries from PE BVTs may be generated from documents through heuristics (e.g., exact-name of friend name, etc.). However, such queries may never be searched by real users. Therefore, improving such synthetic query-sets may not necessarily address real-user problems.

Lack of user context: Document-generated queries may have no idea about the real-user context when users are searching for the query. Previous BVTs may use test user IDs to check correctness of BVTs, while in real scenarios, for a given query, some users may get ideal results while others may fail. In such cases, previous BVTs may not necessarily capture the desired results.

Alternative Approach of PE BVT: Conduit+Dumont

With such problems in mind, another way of building product expectation BVTs may include several steps, as follows:

Step 1: inside of the search logging system (Conduit), certain logics may be implemented to estimate the user intents and possible ideal results based on <user, query, search-context>. For example, given a <query, user-id> in a real search session, all friends of the user may be fetched and matched with the query to know if the user is using that query to search for a friend. With the help of an online BVT, some initial cases may be implemented (e.g. exact-name-connected-friends, exact-match-page-admin, etc.). Such testing cases of <query, user, inferred expected-IDs> may then be logged in both SCUBA and HIVE table search_production_test.

Step 2: <query, user, expected-IDs, search-context> may be sampled from the search_production_test table, and Dumont BVTs may be subsequently generated. The reasons for adding Dumont test may include but are not limited to: 1) the ease of doing offline A/B testing through different QE/SE settings, and 2) the ease of tracking and monitoring the progress and generating a corresponding dashboard.

Therefore, an architecture of PE BVT may include a combination of Conduit and Dumont systems, as seen in FIG. 8. This alternative approach may naturally cover i18n cases. In order to avoid sampling bias, greater than 5K query sets may be run on PE BVTs, and the sampling may be improved by using query sets from the past month. It may be difficult to debug PE BVTs if the query set changes daily.

Templates and Different Examples of PE BVT

In order to facilitate implementing the right set of BVTs, several Dumont response structures may be extended and several BVT templates and helper functions may be initialized as further explained below. Previous implementations may have added thrift fields in the Dumont response for ranking features, resulting in a lot of thrift fields that were difficult to manage and reuse by others. In order to address this problem, a generic interface named “unicorn_ranking_features” and a sitevar named SEARCH_DUMONT_UNICORN_FEATURES_LOG may be added to specify what features are desired in the Dumont response to avoid extensively consuming capacity and efficiency of Dumont tests.

In general, a combination of BVTs may depend on the following information:

Expected-IDs (e.g., IDs on the social network service); Expected-Result-Types (e.g., videos, photos, posts, etc.); Expected-Freshness (e.g., if a result was published within 7 days); and Expect-FeatureValues (e.g., certain features may have a specific value or value distribution).

| BVT names/links BVT | | |
|---|---|---|
| specification BVT types | BVT specification | BVT types |
| event_admin_exact_match_pe_bvt | For a given query and searcher, if the query | Expect-IDs- |
| | exactly matches an event where the searcher | Rank-Top-K |
| | is the admin, then we expect the target event | |
| | to be ranked at top positions on search engine | |
| | result page (“SERP”). | |
| | Similar BVTs: | |
| | group_admin_exact_match_pe_bvt | |
| | group_connected_exact_match_pe_bvt | |
| | User_connected_exact_match_pe_bvt | |
| | For such tests, we need to find expected-ids. | |
| query_object_pattern_result_type_bvt | For a given query and searcher, if the query | Expect- |
| | falls into certain pattern: | Result- |
| | <***> posts ⇒ expect to have posts results | Type-Top-K |
| | <***> photos ⇒ expect to have photo results | |
| | <***> videos ⇒ expect to have video results | |
| | <***> event ⇒ expect to have events results | |
| | <***> group ⇒ expect to have group results | |
| | For such tests, we need to rely on the type_id | |
| | of the unicorn responses | |
| hashtag_query_match_pe_bvt | For a given query and searcher, if the query is | Expect- |
| | in format of “#hashtags”, we expect the results | Result- |
| | as content types and match the hashtags. For | Type-And- |
| | such tests, we need to rely on result-module- | Text |
| | role or result type_id, as well as matching | Matching- |
| | unicorn features like | Top-K |
| | FEATURE_TRV2_EXACT_MATCH_TAID_POST_MAIN_TEXT. | |
| | We can monitor both content- | |
| | trigger-rate-at-top-k and content-matching- | |
| | rate-at-top-k | |
| news_recency_bvt | For a given query and searcher, if the query is a | Expect- |
| | newsy query: | Content- |
| | Expect to have content results (e.g. | Freshness- |
| | videos/posts/etc.) and the results should be fresh. | Top-K |
| | For such tests, it relies on newsy query-intent | |
| | detection, result-types or module-role, as well | |
| | as document_age of the result. | |
| all_query_language_match_pe_bvt | For any query and searcher, we predefine a list | Expect- |
| | of ranking features to identify if the result | FeatureValues- |
| | document has matched with either query or | Top-K |
| | user, and we can define a few types of | |
| | expectations like: | |
| | Expect all results of a query to match either | |
| | query or user languages. If any one of the top- | |
| | k (e.g. 5) results does not match, then this | |
| | query has language-mismatch as 1. | |
| | Expect any of the results of a query to match | |
| | either query or user languages. If any of the | |
| | top-k results match, we treat this query as a | |
| | match case. | |
| | Expect a ratio of language match, e.g. >=80% | |
| | of results need to match the language of | |
| | query or users. | |
| | For such tests, it relies on the accuracy and | |
| | coverage of certain target features (e.g. | |
| | FEATURE_POST_KNOWN_LANGUAGE_BY_USER) | |
| | and it is critical to get those features high accuracy. | |

Query Template and Intent Understanding

A work stream for providing query intent understanding and slot filling is further provided. Several examples about query templates are described below.

Query Sampling

Based on feedback, there may be several principles to follow when query sampling:

Dynamic: In practice, given that the user's search volume may be dynamically changing, it may not be ideal to build a fixed query set at the beginning of the first half of sampling and to improve the query set expecting to get better results at the end of the second half. Keeping the query set dynamic may also avoid the overfitting cases that may occur in the system.

Stable: Compared to a dynamic approach, a stable approach may also be beneficial since the queries should not be expected to change every few hours or every day. Otherwise, debugging and tracking fixes may be difficult.

| Query | Query Templates |
|---|---|
| Statue University | <School> |
| Corporation X | <NonLocalBusiness> |
| John Smith | <PublicFigure> |
| John Smith movies | <PublicFigure> movies |

Representable: the query samples should not be biased towards certain language/locale/etc.; it should be a global traffic sampling. It may be beneficial to avoid the head queries dominating the datasets. To address the problem of head-query dominating query sets, multiple query-sets may be used, where some specific query sets (e.g., sports team-A vs. team-B) may have their own query streams.

Clarity: Ideally the query intent of each query sample of the use-case lists should be clear, otherwise it can create possible conflicts where improving one BVT may hurt another BVT.

Statistic power: the query set should not be too small (e.g., 50 or 100 queries) to help draw clear conclusions (p-values). Ideally it should be a few thousand queries. In order to obtain testing results in a quick manner and avoid Dumont timeout failures, using too many queries (e.g., 50K) should also be avoided.

Expectation Definition

Expectations may be defined in a variety of ways due to ambiguous queries with multiple intents. For example, for a given query, if the match can be a user's joined group name or liked page name, which is preferred? Is any match good enough? How are IEM cases handled? IEM might present one connected exact match user but with unconnected information, while connected information may be available.

For L1 expectation, it may be desirable to aim at vital-recall for top-1 for clear cases, and if the vital is not at top-1, anyone above it should have a higher or at least equal priority (e.g., exact-match and connectedness). Alternatively, we may exclude those overlapping cases to make the test recall_at_1 definition clearer.

Log the Online BVT (Conduit Testing)

A table named “search_production_test” may be used to log all online BVT tests. The table may be extended to output more columns if needed. Specifically, the gk_exposure column, together with the qe_exposures column, may be used to easily determine if the users are in some specific setting, etc.

Dumont Config Behaviors

There is a risk of seeing BVT changes not reflected in production due to the fact that users may be triggering some holdout behavior due to GK or QE settings. Ideally, the “search_production_test” table may be leveraged to do such user selection. Additionally, a principle on the default behavior of Dumont may be established to avoid misleading cases (e.g., Vanilla production). To run the test with multiple rounds, or at least with one thousand or more queries, there may be some setting optimization so that the Dumont run of all PE BVTs may be successful.

Common Questions/Answers About Evaluation

| Question | Answer |
|---|---|
| # of queries per each BVT need | 1000, based on a few considerations: |
| | runtime taken from all PE BVTs |
| | Stat-sig power from exps (p-value |
| | computation) |
| # of rounds per BVT | 3 based on a few considerations: |
| | Stability of SERPs |
| Query set specification | Clear intent: |
| | Each PE BVT owner should write Clear |
| | intent |
| | Ambiguous intent: |
| | Several BVTs generated from Online |
| | logging |
| Dumont Config Setting | Vanilla production/holdout based |
| | We will keep tracking 2 lines: 1 for |
| | production, 1 for holdout. This is joint |
| | efforts with holdout building v-team. |

### Example Apparatuses, Systems, and Methods for Hardware Virtualization and Simulation for Server Hosting

The cloud may provide a hardware and software runtime environment that emulates an execution environment for third-party applications originally built to execute on end-user devices such as cell phones (e.g., in an Android™ operating system) and desktop computers (e.g., in a WINDOWS® operating system). The cloud gaming environment may then host the third-party applications. The emulated execution environment may be provided as a typical environment for the end-user devices and/or for the desktop computers that may be implemented on commodity server hardware. The emulated execution environment may include hardware virtualization that may provide strong security and performance guarantees due to the isolation of the execution of the third-party application on the dedicated hardware. The hardware and software runtime may be standardized across the service provided by the cloud gaming environment so that game performance is consistent and independent of which commodity server hardware runs the individual runtime instance of the third-party application.

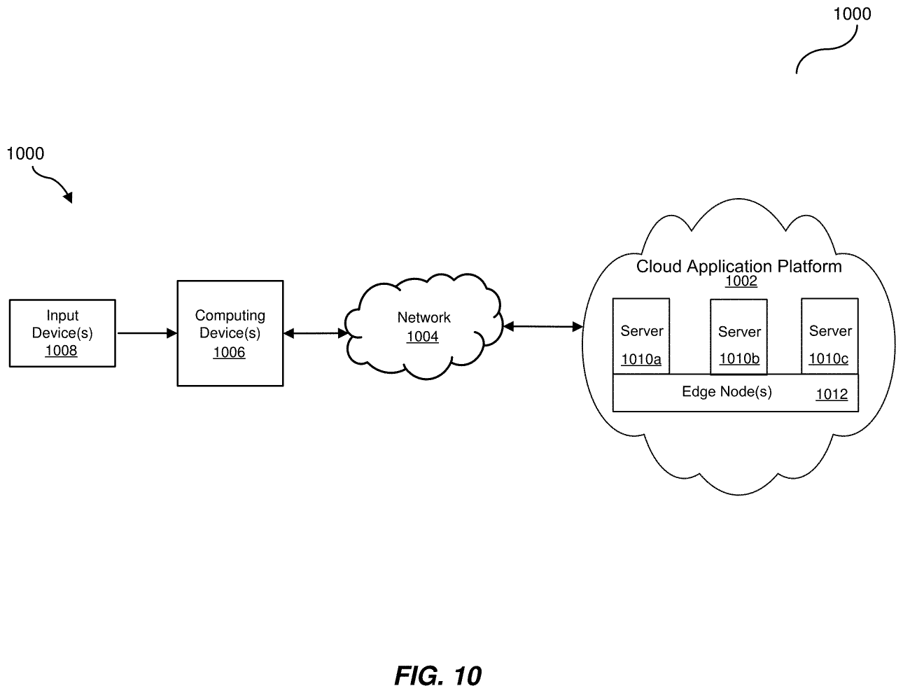

FIG. 10A is an illustration of an exemplary system 1000 for hosting an application in a server-side environment. The system 1000 may include a cloud application platform 1002 communicating with a computing device 1006 over a network 1004. In some embodiments, the term “server-side” may refer to a classification of resources that run on a server or other suitable platform to generate and/or deliver content over a network to a computing device (e.g., the computing device 1006). The cloud application platform 1002 may include servers and other software and hardware to host, run, and/or execute an application in the cloud to provide content to the computing device 1006. The content may include, but is not limited to, graphics content and audio content.

In some implementations, the network 1004 may be the Internet, a Local Area Network (LAN), a Wide Area Network (WAN), or any type of communication network that implements various types of communication protocols and/or physical connections. The computing device 1006 may be a client device. For example, a user (e.g., an end-user) may interact with the computing device 1006 when interfacing with an application executing in the cloud application platform 1002. In addition, or in the alternative, a user may view content provided by the cloud application platform 1002 that may be presented on a display device included in the computing device 1006. The computing device 1006 may receive the content from the cloud application platform 1002 in a web browser or other application executing locally on the computing device 1006.

A remote device may communicate with, may be connected to (wired or wirelessly), and/or otherwise be interfaced with an input device. For example, the computing device 1006 may be in communication with an input device 1008. In some implementations, the computing device 1006 may include the input device 1008. In some implementations, the input device 1008 may be in wired or wireless communication with the computing device 1006. The wireless communication may be implemented using a wireless communication protocol that may include, but is not limited to, Wi-Fi, BLUETOOTH, cellular, radio, or any other type of wireless communication protocol. The input device 1008 may provide input to computing device 1006. The computing device 1006 may then provide information and data to the cloud application platform 1002 by way of the network 1004. The cloud application platform 1002 may use the information and data to control the application executing in the cloud application platform 1002. The control of the application may be based, at least in part, on the input received from input device 1008.

A cloud application platform may include a plurality of servers. In the example shown in FIG. 10, the cloud application platform 1002 includes three servers 1010a-c. In some implementations, a cloud application platform may include less than three servers (e.g., two servers, one server). In some implementations, a cloud application platform may include more than three servers.

A cloud application platform may utilize edge computing to efficiently receive an input data stream and to efficiently serve content using an output video and/or audio data stream. The receiving and outputting of data streams may be from cloud servers to computing devices by way of a network. In some implementations, the cloud application platform 1002 may utilize edge computing to efficiently receive the input data stream and to efficiently serve the video and/or audio data stream (e.g., content) from cloud servers to the computing device 1006 by way of the network 1004.

The system 1000 may advantageously allow developers to build applications intended to execute on one computing platform (e.g., operating system) to reach other users operating different computer platforms, and further may provide users with immediate access to applications regardless of device capabilities, such as games, and other applications that provide streaming media content. These advantages may be realized with system 1000 by using virtualization technology to run applications in virtual hosting environments on top of a base operating system. Example virtual hosting environments may include, for example, Android™ virtual environments, MICROSOFT® WINDOWS® virtual machine (“VM”), and/or other container technologies.

In some implementations, the system 1000 may be a cloud gaming system that hosts game applications in a server-side environment. The use of edge computing may allow the system 1000 to meet response-time constraints for real-time gaming in a cloud gaming system by providing real-time responses and interactions resulting in adequate performance for a game along with a suitable user experience when the game is run as a cloud-hosted application executing in a cloud-hosted infrastructure environment.

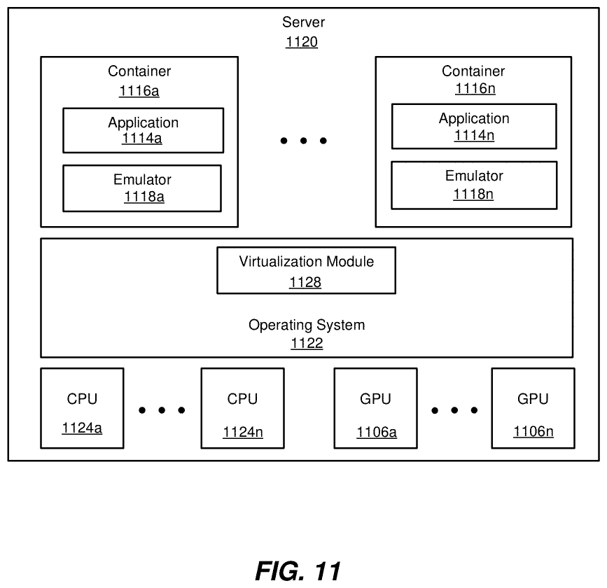

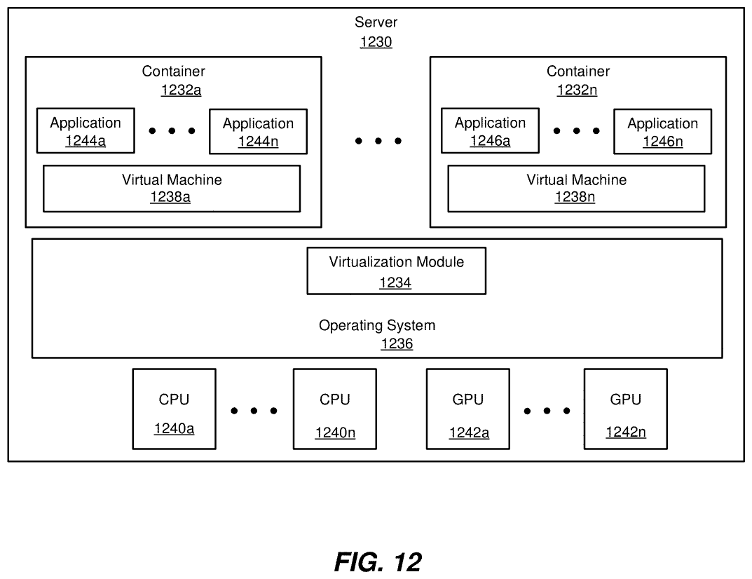

FIG. 11 is an illustration of an example server 1120 included in a cloud application platform that hosts applications in a server-side environment. FIG. 12 is an illustration of another example server 1230 included in a cloud application platform that hosts applications in a server-side environment. A cloud application platform may provide a server-side hosted environment for executing an application (e.g., a cloud-hosted application). Each server 1120, 1230 may include hardware, firmware, and/or software for hosting an application in a server-side environment. For example, the cloud application platform 1002 may provide a cloud-hosted infrastructure environment that is architected to include at least one remote server (e.g., servers 1010a-c). Each remote server may include at least one execution environment (e.g., emulators 1118a-n, virtual machines 1238a-n) for running at least one application (e.g., applications 1114a-n, applications 1244a-n) in a container (e.g., containers 1116a-n, containers 1232a-n). The server 1120 and the server 1230 may use virtualization technology to run applications in a virtual hosting environment (e.g., virtualization module 1128 and virtualization module 1234, respectively) on top of a base operating system (OS) (e.g., OS 1122 and OS 1224, respectively). Example virtual hosting environments may include, for example, Android™ virtual environments, MICROSOFT® WINDOWS® virtual machine (“VM”), and/or other container technologies.

A server may execute an operating system. For example, referring to FIG. 11, the server 1120 may execute an operating system 1122 in communication with, and running on, one or more central processing units (CPUs) 1124a-n. The operating system 1122 may also be in communication with one or more graphics processing units (GPUs) 1106a-n for image and graphics processing. For example, referring to FIG. 12, the server 1230 may include any suitable number of CPUs 1240a-n and GPUs 1242a-n. For example, the server 1230 may execute an operating system 1236 in communication with, and running on, one or more central processing units (CPUs) 1240a-n. The operating system 1236 may also be in communication with one or more graphics processing units (GPUs) 1242a-n for image and graphics processing. The server 1230 may include any suitable number of CPUs 1240a-n and GPUs 1242a-n.

An operating system may interact with one or more edge nodes in an edge computing environment. For example, referring to FIGS. 10-12, the operating system 1122 and the operating system 1236 may be operating systems that interact with edge nodes (e.g., the edge node(s) 1012) in an edge computing environment. The operating system 1122 and the operating system 1236 may include a virtualization module 1128 and a virtualization module 1234, respectively. The virtualization module 1128 and the virtualization module 1234 may provide software and operating system virtualization capabilities that allow the cloud application platform 1002 to support multiple, isolated virtual environments. In some implementations, the virtualization module 1128 and the virtualization module 1234 may be virtual machines (e.g., a Kernel-based Virtual Machine (KVM)).

A container may include an application layer that packages code, dependencies, and configuration files together to create an entire runtime environment for the container. For example, any suitable container may be used such as a container system that may include a base operating system layer and a customization layer included in a hosted environment, and an application layer.

Referring to FIG. 11, the operating system 1122 and the virtualization module 1128 may support one or more containers 1116a-n. Each container 1116a-n may be a virtualized software unit that provides an isolated environment for software execution. Each container 1116a-n may provide a sandboxed environment to execute a respective hosted environment (e.g., emulators 1118a-n). Likewise, each emulator 1118a-n may, in turn, execute a respective application 1114a-n. In some implementations, a hosted environment may be a containerized operating system. For example, a hosted environment may be an Android™ Emulator that emulates an Android™ operating system. Each application 114a-n may be a game designed to execute in an Android™ operating system operating on a mobile computing device.

Referring to FIG. 12, the operating system 1236 and the virtualization module 1234 may support one or more containers 1232a-n. Each container 1232a-n may be a virtualized software unit that provides an isolated environment for software execution. Each container 1232a-n may provide a sandboxed environment to execute a respective hosted environment (e.g., virtual machines 1238a-n). Likewise, each virtual machine 1238a-n may, in turn, execute one or more respective applications. For example, the virtual machine 1238a may execute applications 1244a-n. For example, virtual machine 1238n may execute applications 1246a-n. In some implementations, a hosted environment may be a containerized operating system. For example, a hosted environment may be an and a MICROSOFT® WINDOWS® Virtual Machine that virtualizes WINDOWS® operating system. Each application 344a-n and each application 346a-n may be a game designed to execute in a WINDOWS® operating system operating on a desktop or laptop computing device.

Implementing a server-side architecture that includes an application and a hosted environment in a container, and that includes a virtualization module and/or an operating system may provide security among different applications (e.g., non-native applications) executing in the server-side hosted environment. Referring to FIG. 11, the architecture allows the execution environment for one application (e.g., the application 1114a) to be isolated from the execution environment for another application (e.g., the application 1114n). Such isolated, containerized execution of an application may provide increased security and performance guarantees by isolating execution to dedicated hardware. The hardware and software runtime may be standardized such that application performance may be consistent regardless of which server or which server hardware runs the individual runtime instance. The hardware and software runtime may therefore provide virtualization at scale.

Referring to FIG. 12, the architecture allows the execution environment for a first set of applications (e.g., the applications 1244a-n) to be isolated from the execution environment for a second set of applications (e.g., the applications 1246a-n). Such isolated, containerized execution of each set of applications may provide increased security and performance guarantees by isolating execution of each set of applications to dedicated hardware. The hardware and software runtime may be standardized such that the performance of the first set of applications and the second set of applications may be consistent regardless of which server or which server hardware runs the individual runtime instance. The hardware and software runtime may therefore provide virtualization at scale.

A cloud application platform 1002 may provide various optimizations to allow for enhanced execution of an application not designed to operate in a server-side hosted environment (e.g., an application non-native to the server-side hosted environment (a non-native application or a local application)). In some implementations, referring to FIG. 11, the cloud application platform 1002 may provide a hardware and software runtime in the cloud that emulates the execution environment for these third-party applications originally built to execute on end-user devices such as cell phones (e.g., in an Android™ operating system). In some implementations, referring to FIG. 12, the cloud application platform 1002 may virtualize hardware for the server-side hosted environment that is native to the execution environment of an application. The application may then be executed in the server-side hosted environment, which is not native to the application, by the virtualized hardware. The virtualized hardware may enable the application that is non-native to the server-side hosted environment to execute in the server-side hosted environment and desktop and/or laptop computers (e.g., in a WINDOWS® operating system).

The cloud application platform 1002 may host the third-party applications by providing an emulated and/or virtual environment for execution of the applications by implementing the environments on commodity server hardware. The emulated and/or virtual execution environment may include hardware emulations and/or virtualization that may provide stronger security and performance guarantees due to the isolation of the execution of the third-party application on dedicated hardware.

In some implementations, an application may be a game (e.g., a video game). For example, the game may be an existing game designed to execute on a computing device of a user. For example, the game may be a mobile application. The system 1000 may host and provide cloud-delivery for an existing game designed for varying hardware and/or software platforms. The cloud-delivery of the existing game may allow a user to play on the game on the computing device of the user without performance degradation and without the need for substantial modifications to the game.

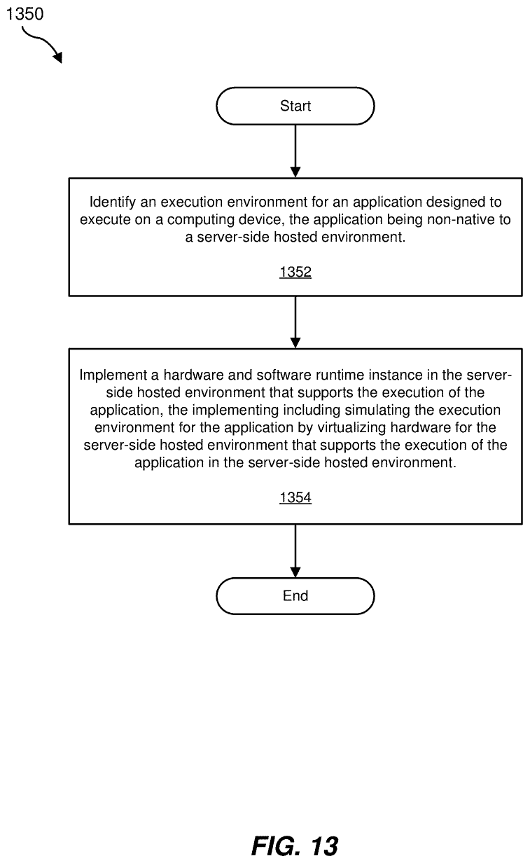

FIG. 13 is a flow diagram of an exemplary method 1350 for implementing hardware virtualization and simulation for server hosting. In some implementations, a server-side hosted environment may be for server hosting of a cloud gaming system. The steps shown in FIG. 13 may be performed by any suitable computer-executable code and/or computing system, including the system(s) illustrated in FIGS. 10-12. In one example, each of the steps shown in FIG. 13 may represent an algorithm whose structure includes and/or is represented by multiple sub-steps, examples of which will be provided in greater detail below.

As illustrated in FIG. 13, at step 1352 one or more of the systems described herein may identify an execution environment for an application designed to execute on a computing device. The application may be non-native to a server-side hosted environment. For example, referring to FIGS. 10-12, the cloud application platform 1002 may identify an execution environment for an application designed to execute on the computing device 1006. The application may be a non-native application to the server-side hosted environment provided by server 1120 and/or server 1230. to a server-side hosted environment.

In some embodiments, the term “execution environment” may refer to an environment for a computing device in which an application is executed. Examples of execution environments may include, without limitation, an execution environment includes an operating system that may execute applications bunt to execute on mobile computing devices (e.g., an Android™ operating system), and an execution environment may include an operating system that may execute applications built to execute on desktop computing devices and/or laptop computing devices (e.g., in a WINDOWS® operating system).

In some embodiments, the term “non-native application” may refer to an application originally designed or built to execute in a particular execution environment that is then executed in a different execution environment. Examples of non-native applications may include, without limitation, applications designed and/or built to execute in one operating system that is then executed in a server-side hosted environment that simulates the operating system.

In some embodiments, the term “server-side hosted environment” may refer to a cloud-hosted infrastructure environment that is architected to include at least one remote server, an execution environment, and hardware for implementing and running a cloud-hosted system for hosting an application non-native to the execution environment of the cloud-hosted infrastructure. Examples of a server-side hosted environment may include, without limitation, a data center that includes one or more spaces or areas in the data center where one or more servers and other equipment may directly connect to an Internet network backbone (e.g., one or more colocation centers). For example, a colocation center may be a data center space for server(s) and equipment that virtualize and/or emulate an operating system environment for executing non-native applications in the cloud.

The systems described herein may perform step 352 in a variety of ways. In one example, referring to FIGS. 10 and 11, the cloud application platform 1002 may identify an execution environment for an application designed to execute on the computing device 1006. The application may be an application originally built to execute on end-user devices such as cell phones or other types of mobile computing devices in an Android™ operating system that is non-native to a server-side hosted environment. In one example, referring to FIGS. 10 and 12, the cloud application platform 1002 may identify the execution environment provided by the server 1230 as the server-side hosted environment for executing the application. The application may be an application originally built to execute on end-user devices such as desktop computers and/or laptop computers in a WINDOWS® operating system that is non-native to a server-side hosted environment.

As illustrated in FIG. 13, at step 1354 one or more of the systems described herein may implement a hardware and software runtime instance in the server-side hosted environment that supports the execution of the application. The implementing may include simulating the execution environment for the application by virtualizing hardware for the server-side hosted environment that supports the execution of the application in the server-side hosted environment. For example, referring to FIGS. 10-12, an operating system (e.g., the operating system 1122, the operating system 1236) and a virtualization module (e.g., the virtualization module 1128, the virtualization module 1234) may support one or more containers (e.g., the containers 1116a-n, the containers 1232a-n). Each container may be a virtualized software unit that provides an isolated sandboxed environment to execute a respective hosted environment (e.g., the emulators 1118a-n, the virtual machines 1238a-n) and one or more applications (applications 1114a-n, applications 1244a-n, and applications 1246a-n). In some implementations, a hosted environment may be a containerized operating system.

In some embodiments, the term “runtime instance” may refer to an occurrence of a software object that exists during the runtime of computer program. Examples of a runtime instance may include, without limitation, a hardware and software runtime instance that may be a software object that simulates an execution environment for an application by emulating or and/or a virtualizing hardware and/or an operating system environment in a server-side hosted environment to support the execution of a non-native application in the server-side hosted environment.

In some embodiments, the term “simulating” may refer to emulating and/or virtualizing an instance of a computer system (e.g., computer hardware and/or software) in a container that may be abstracted from the actual hardware of the host computing system. Examples of simulating may include, without limitation, emulating an execution environment for an application originally built to execute on end-user devices such as cell phones or other types of mobile computing devices in an Android™ operating system that is non-native to a server-side hosted environment, and virtualizing an execution environment for an application originally built to execute on end-user devices such as desktop computers and/or laptop computers in a WINDOWS® operating system that is non-native to a server-side hosted environment.

In some embodiments, the term “virtualizing” may refer to running or executing a virtual instance of a computer system (e.g., computer hardware and/or software) in a container that may be abstracted from the actual hardware of the host computing system. Examples of virtualizing may include, without limitation, creating one or more containers in an edge OS host for virtualizing hardware in the edge OS host for executing an application non-native to the computing environment of the edge OS host.

The systems described herein may perform step 1354 in a variety of ways. In one example, referring to FIGS. 10-11, the operating system 1122 and the virtualization module 1128 may support one or more containers 1116a-n. Each container 1116a-n may be a virtualized software unit that provides an isolated environment for software execution. Each container 1116a-n may provide a sandboxed environment to execute a respective hosted environment (e.g., emulators 1118a-n). Likewise, each emulator 1118a-n may, in turn, execute a respective application 1114a-n. In some implementations, a hosted environment may be a containerized operating system. For example, a hosted environment may be an Android™ Emulator that emulates an Android™ operating system. Each application 1114a-n may be a game designed to execute in an Android™ operating system operating on a mobile computing device. In another example, referring to FIGS. 10 and 12, the operating system 1236 and the virtualization module 1234 may support one or more containers 1232a-n. Each container 1232a-n may be a virtualized software unit that provides an isolated environment for software execution. Each container 1232a-n may provide a sandboxed environment to execute a respective hosted environment (e.g., virtual machines 1238a-n). Likewise, each virtual machine 1238a-n may, in turn, execute one or more respective applications. For example, the virtual machine 1238a may execute applications 1244a-n. For example, virtual machine 1238n may execute applications 1246a-n. In some implementations, a hosted environment may be a containerized operating system. For example, a hosted environment may be an and a MICROSOFT® WINDOWS® Virtual Machine that virtualizes WINDOWS® operating system. Each application 1244a-n and each application 1246a-n may be a game designed to execute in a WINDOWS® operating system operating on a desktop or laptop computing device.

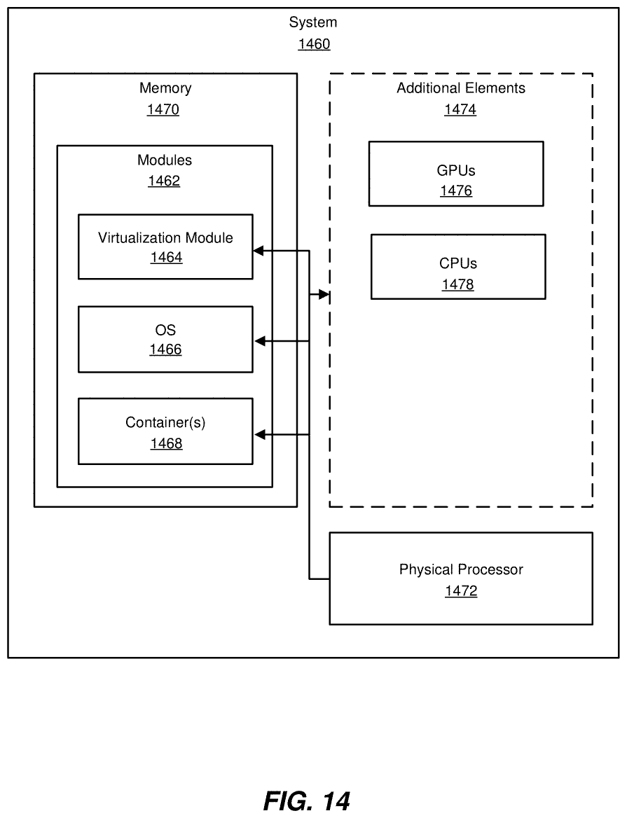

FIG. 14 is a block diagram of an example system 1460 that includes modules 1462 for use in implementing a cloud gaming system in a server-side hosted environment. The modules 1462 may include a virtualization module 1464 (e.g., the virtualization module 1128, the virtualization module 1234). The modules 1462 may include an operating system (OS) module 1466 (e.g., the OS 1122, the OS 1236). The modules 1462 may include container(s) 1468 (e.g., the containers 1116a-n, the containers 1232a-n). Although illustrated as separate elements, one or more of modules 1462 in FIG. 14 may represent portions of a single module or application.

In certain embodiments, one or more of modules 1462 in FIG. 14 may represent one or more software applications, operating systems, or programs that, when executed by a computing device, may cause the computing device to perform one or more tasks. As illustrated in FIG. 14, the example system 1460 may also include one or more memory devices, such as memory 1470. Memory 1470 generally represents any type or form of volatile or non-volatile storage device or medium capable of storing data and/or computer-readable instructions. In one example, memory 1470 may store, load, and/or maintain one or more of modules 1462. Examples of memory 1470 may include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 14, the example system 1460 may also include one or more physical processors, such as physical processor 1472. Physical processor 1472 generally represents any type or form of hardware-implemented processing unit capable of interpreting and/or executing computer-readable instructions. In one example, the physical processor 1472 may access and/or modify one or more of modules 1462 stored in memory 1470. Additionally, or alternatively, physical processor 1472 may execute one or more of modules 1462. Examples of the physical processor 1472 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 14, the example system 1460 may also include one or more additional elements 1474. The additional elements 1474 generally represent any type or form of hardware and/or software. In one example, the physical processor 1472 may access and/or modify one or more of the additional elements 1474.

One or more repositories may include the additional elements 1474. The one or more repositories may be memory (e.g., the memory 1470). The one or more repositories may be databases. In some implementations, the additional elements 1474 may be included (part of) the system 1460. In some implementations, the additional elements 1474 may be external to the system 1460 and accessible by the system 1460. The additional elements 1474 may include GPUs 1476 and/or CPUs 1478 (e.g., the GPUs 1106a-n and the CPUs 1124a-n, and the GPUs 1242a-n and the CPUs 1240a-n).

### Example Systems and Methods for Filtering Network Traffic in a Hosting Environment

Hosting environments that act as application hosting platforms may host third-party software applications and other services for users to access through online networks. For example, a cloud gaming environment can host various third-party gaming applications so that users can access and play games through a social media platform. In these cases, hosting environments may not fully trust third-party applications or may not be able to verify the security of these applications.

Traditionally, host systems may attempt to control network traffic between outside devices, such as client devices, and host servers or service locations. However, as hosting environments grow larger in scale, the flow of network traffic can become more difficult to manage. Additionally, network traffic rules can be increasingly complex when hosting environments have dynamic infrastructures and service locations can constantly change. Thus, better methods of managing the network traffic of third-party applications are needed to improve security in hosting environments.

The present disclosure is generally directed to systems and methods for protecting hosting environments from malicious network traffic. As will be explained in greater detail below, embodiments of the present disclosure may, by implementing a kernel component for network traffic filtering, reduce the latency in traffic filtering. The systems and methods described herein may first use the kernel component to provide security by filtering all network traffic for a hosting environment. For example, the disclosed systems and methods may identify requests for hosted services or third-party applications and redirect the traffic to a kernel-level security filter to determine whether the requested service follows network security rules. The disclosed systems and methods may then implement an application that monitors service directory changes to manage the configuration of the kernel component. The disclosed systems and methods may also dynamically update the configuration of the kernel component with changes to valid service location targets. For example, a network ruleset may be dynamically synced with a central service directory, and updates may be automatically integrated to security rules for the hosting environment to isolate parts of the hosting environment. Furthermore, the disclosed systems and methods may utilize the kernel-level filter to determine if network traffic should be forwarded to destination locations based on the dynamically updated ruleset.

In addition, the systems and methods described herein may improve the functioning of a computing device by improving the management of hosting environment network traffic to reduce latency using a kernel component. These systems and methods may also improve the fields of network security and network isolation by dynamically updating network traffic rules based on a dynamically updated service directory. Thus, the disclosed systems and methods may improve over traditional methods of network traffic filtering for hosting environments.

Features from any of the embodiments described herein may be used in combination with one another in accordance with the general principles described herein. These and other embodiments, features, and advantages will be more fully understood upon reading the following detailed description in conjunction with the accompanying drawings and claims.

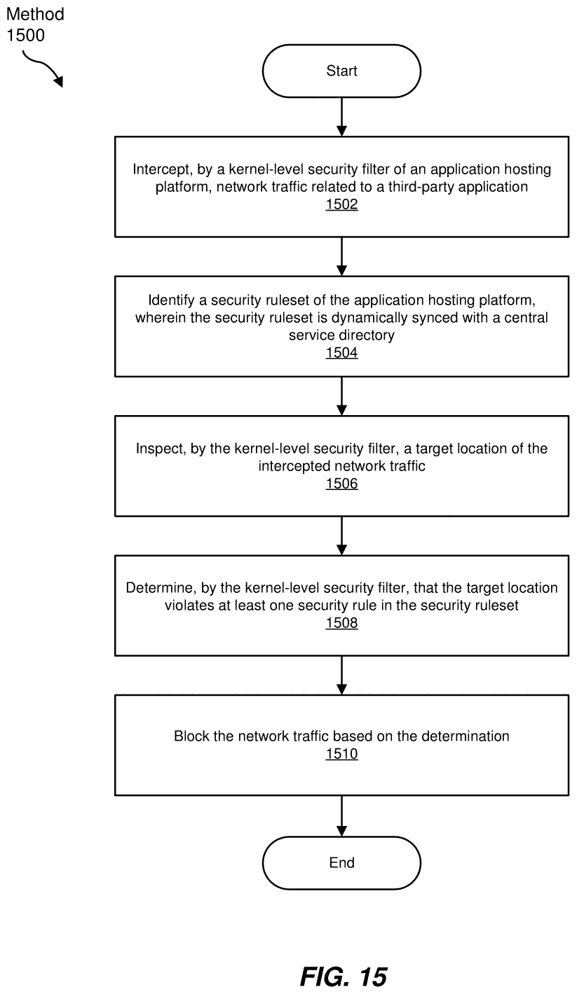

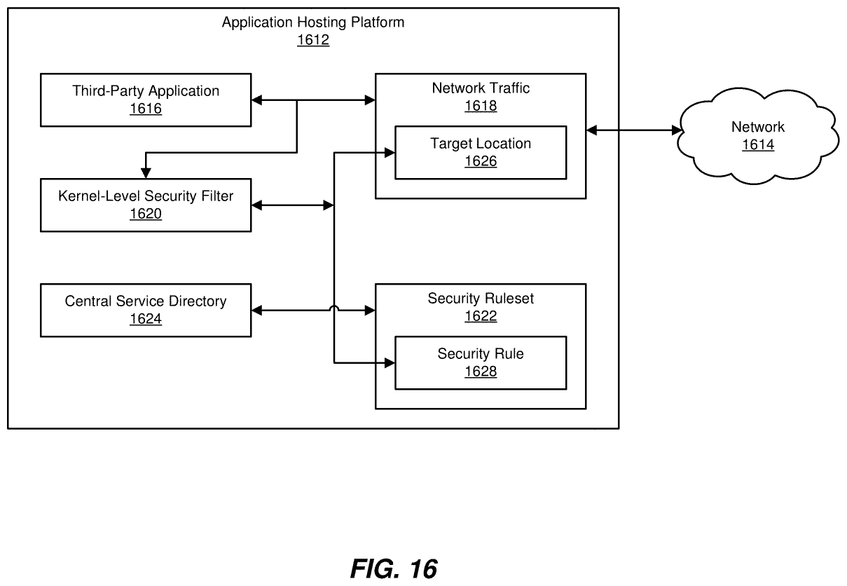

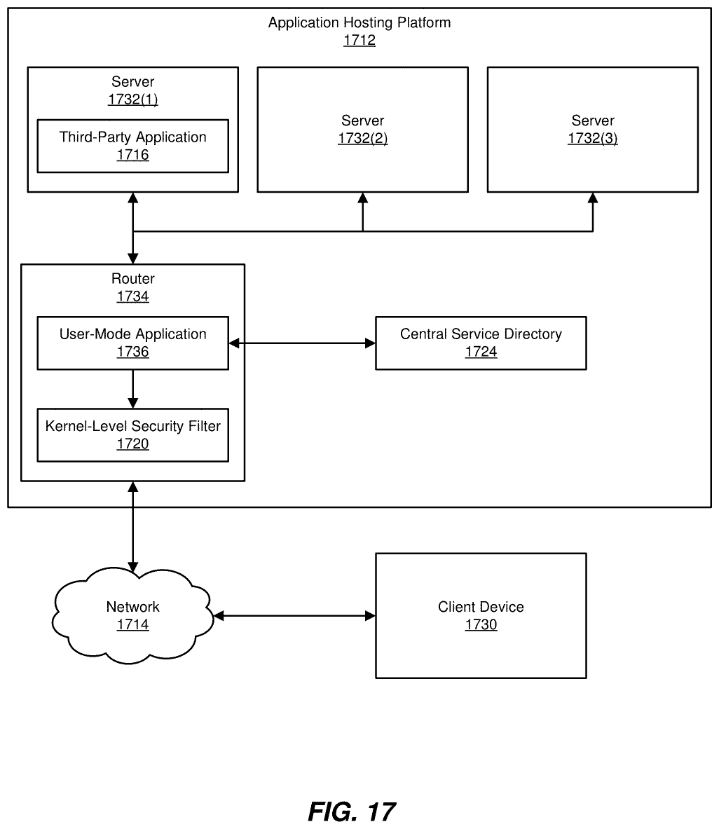

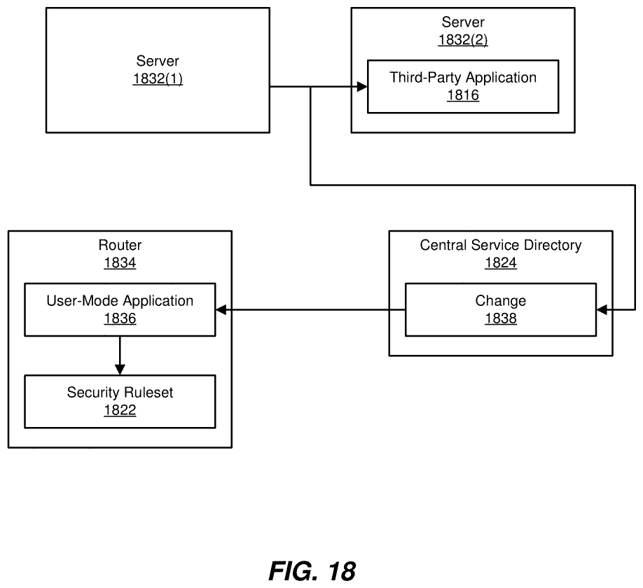

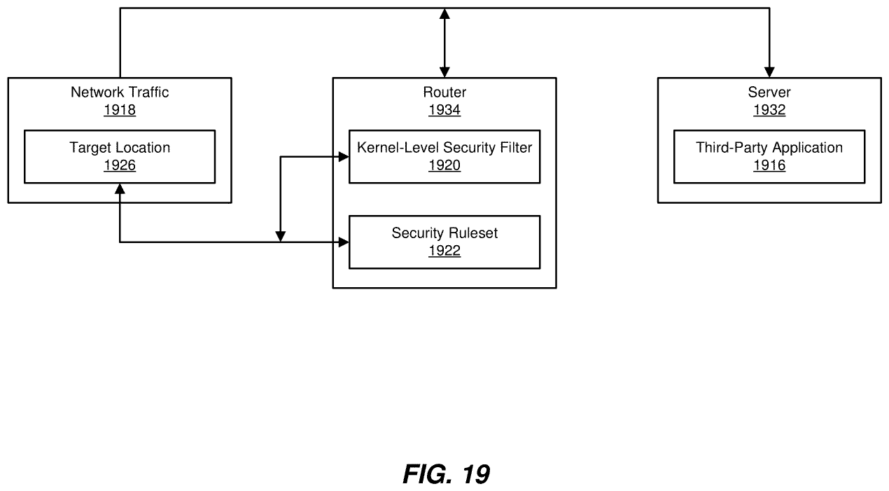

The following will provide, with reference to FIG. 15, detailed descriptions of computer-implemented methods for filtering network traffic in a hosting environment. Detailed descriptions of a corresponding exemplary system will be provided in connection with FIG. 16. Detailed descriptions of an exemplary user-mode application of an exemplary router for managing an exemplary kernel-level security filter will be provided in connection with FIG. 17. In addition, detailed descriptions of an exemplary update to an exemplary security ruleset based on a change to an exemplary central service directory will be provided in connection with FIG. 18. Finally, detailed descriptions of an exemplary router forwarding exemplary network traffic to an exemplary target location will be provided in connection with FIG. 19.

FIG. 15 is a flow diagram of an exemplary computer-implemented method 1500 for filtering network traffic in a hosting environment. The steps shown in FIG. 15 may be performed by any suitable computer-executable code and/or computing system, including application hosting platform 1612 illustrated in FIG. 16. In one example, each of the steps shown in FIG. 15 may represent an algorithm whose structure includes and/or is represented by multiple sub-steps, examples of which will be provided in greater detail below.

As illustrated in FIG. 15, at step 1502 one or more of the systems described herein may intercept network traffic related to a third-party application. For example, FIG. 16 is a block diagram of an exemplary system for filtering network traffic in a hosting environment. As illustrated in FIG. 16, a kernel-level security filter 1620 of an application hosting platform 1612 may intercept network traffic 1618 related to a third-party application 1616.

In some embodiments, the terms “hosting environment” and “application hosting platform” may refer to a physical or virtualized environment for managed services hosting. Examples of hosting environments and application hosting platforms include, without limitation, website hosting, application hosting, cloud computing, cloud gaming, social network platforms, and/or any other form of shared or dedicated hosting for third parties. In some embodiments, the term “third-party application” may refer to a software application created by one entity and running in a hosting environment run by a separate entity. In some embodiments, the term “kernel” may refer to a core program with control over the operating system of a computing device. In these embodiments, the term “kernel-level security filter” may refer to kernel-level software or dedicated hardware with a kernel component that intercepts and redirects network traffic.

In some embodiments, application hosting platform 1612, kernel-level security filter 1620, and/or servers of application hosting platform 1612 may represent one or more computing devices, servers, and/or virtual machines that may execute method 1500 and/or may store all or a portion of the data described herein. For example, application hosting platform 1612 may represent a networked collection of computing devices and servers that are capable of storing and/or managing third-party applications, such as third-party application 1616, and may be capable of reading computer-executable instructions. Additional examples of the above servers and computing devices may include, without limitation, application servers, database servers, and/or proxy servers configured to provide various database services and/or run certain software applications, such as video streaming and gaming applications.

The systems described herein may perform step 1502 in a variety of ways. In one example, kernel-level security filter 1620 may intercept all network traffic, including network traffic 1618, over a network 1614 for application hosting platform 1612. In some embodiments, the term “network” may refer to any medium or architecture capable of facilitating communication or data transfer. Examples of networks include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), or the like. For example, network 1614 may represent an Internet connection enabling client devices to connect to application hosting platform 1612, such as network 1004 of FIG. 10 enabling a connection between computing devices 1006 and cloud application platform 1002.

In one example, kernel-level security filter 1620 may represent a router with a kernel component in charge of receiving and forwarder all incoming and outgoing network traffic from network 1614. In some embodiments, the term “router” may refer to a hardware and/or a software component that receives and redirects network traffic and determines where to send the network traffic. In other examples, kernel-level security filter 1620 may represent a kernel component on a server or on multiple servers of application hosting platform 1612 that manages the traffic for the server or servers.

Returning to FIG. 15, at step 1504, one or more of the systems described herein may identify a security ruleset of the application hosting platform, wherein the security ruleset is dynamically synced with a central service directory. For example, kernel-level security filter 1620 may, as part of application hosting platform 1612 in FIG. 16, identify a security ruleset 1622 of application hosting platform 1612, wherein security ruleset 1622 may be dynamically synced with a central service directory 1624.

The systems described herein may perform step 1504 in a variety of ways. In some embodiments, the term “security ruleset” may refer to a set of rules for managing the security of a hosting environment. For example, a security ruleset may include rules for network isolation, which may dictate how the hosting environment is segmented based on levels of trust and/or services provided by servers of the hosting environment. For example, security ruleset 1622 may dictate which client devices or user accounts may access or run specific third-party applications. In some embodiments, the term “service directory” may refer to a directory indicating the services provided by each server of the hosting environment, the location of each server, and/or other identifying information about each server. In some embodiments, central service directory 1624 may be stored in a central database of application hosting platform 1612 that is accessible to kernel-level security filter 1620 and/or various servers of application hosting platform 1612.

In one embodiment, kernel-level security filter 1620 may store security ruleset 1622 in a local database to quickly access security ruleset 1622. In this embodiment, the disclosed systems and methods may periodically update security ruleset 1622 by synching with central service directory 1624. Additionally, central service directory 1624 may dynamically update with any detected changes to locations of servers or changes to which servers provide which services. For example, a gaming application hosted on a server may be moved to a different server. In another example, a server may be physically removed from or added to application hosting platform 1612, resulting in readdressing of servers. In these example, central service directory 1624 may be alerted to the changes, and security ruleset 1622 may subsequently adjust to redefine rules for client access to the servers or services.

Returning to FIG. 15, at step 1506, one or more of the systems described herein may inspect a target location of the intercepted network traffic. For example, kernel-level security filter 1620 may, as part of application hosting platform 1612 in FIG. 16, inspect a target location 1626 of intercepted network traffic 1618.

The systems described herein may perform step 1506 in a variety of ways. In some examples, target location 1626 may represent a location of a server expected to host third-party application 1616. For example, a user may attempt to run a gaming application on a social media platform, and a client computing device may request the gaming application from a location of application hosting platform 1612. In this example, target location 1626 may represent a specific requested server. In other examples, target location 1626 may represent a segment of application hosting platform 1612 used to host gaming applications, such as third-party application 1616. Alternatively, target location 1626 may represent a request by a client device to run third-party application 1616 on application hosting platform 1612 without specifying an exact server or location. In this example, kernel-level security filter 1620 may identify a potential server or location known to host third-party application 1616 based on central service directory 1624.

Returning to FIG. 15, at step 1508, one or more of the systems described herein may determine that the target location violates at least one security rule in the security ruleset. For example, kernel-level security filter 1620 may, as part of application hosting platform 1612 in FIG. 16, determine that target location 1626 violates a security rule 1628 in security ruleset 1622.

The systems described herein may perform step 1508 in a variety of ways. In some embodiments, kernel-level security filter 1620 may determine that target location 1626 indicates a request for third-party application 1616 for a client device that does not have permission to access third-party application 1616, based on security rule 1628. In other embodiments, kernel-level security filter 1620 may determine security rule 1628 specifies certain circumstances for network traffic 1618, such as limits to an existing number of applications run by a user account or a volume of network traffic for the client device. Additionally, security rule 1628 may specify network isolation rules that indicate network traffic 1618 is not authorized to access target location 1626. Alternatively, kernel-level security filter 1620 may determine that target location 1626 violates a combination of security rules rather than a single rule.

Returning to FIG. 15, at step 1510, one or more of the systems described herein may block the network traffic based on the determination. For example, kernel-level security filter 1620 may, as part of application hosting platform 1612 in FIG. 16, block network traffic 1618 based on the determination.

The systems described herein may perform step 1510 in a variety of ways. In one embodiment, kernel-level security filter 1620 may simply drop any network packets of network traffic 1618. In some examples, the term “network packet” may refer to a unit of data formatted to be able to transmit over a network. In other embodiments, kernel-level security filter 1620 may block network traffic 1618 by blocking a client device sending network traffic 1618. In further embodiments, kernel-level security filter 1620 may send information about blocked network traffic 1618 and/or violated security rule 1628 to the origin client device.

In some examples, the systems and methods described herein may further include a user-mode application that may manage the kernel-level security filter. In these examples, the user-mode application may monitor the central service directory, detect a change to the central service directory, and update the security ruleset based on the detected change to the central service directory. In some embodiments, the term “user mode” may refer to an operating system mode for running user applications, such as a gaming application hosted by a hosting environment. In contrast, kernel-level security filter 1620 may run in a kernel mode, which may reduce latency by not switching between from kernel mode to user mode to filter network traffic. In some embodiments, the term “kernel mode” may refer to an operating system mode for executing processes performed by the kernel of the operating system.

As illustrated in FIG. 17, a user-mode application 1736 may manage kernel-level security filter 1720 as part of a router 1734 for application hosting platform 1712. In this example, user-mode application 1736 may monitor changes to central service directory 1724, which may track all services and applications for servers 1732(1)-(3). Additionally, in this example, kernel-level security filter 1720 may intercept all network traffic, such as traffic from a client device 1730 requesting third-party application 1716 hosted by server 1732(1). For example, all traffic from network 1714 may flow through router 1734 to access any of servers 1732(1)-(3) of application hosting platform 1712.

As illustrated in FIG. 18, third-party application 1816 may be moved from server 1832(1) to server 1832(2). For example, server 1832(1) may be removed from application hosting platform 1812 for maintenance. As another example, third-party application 1816 may be moved based on security requirements for gaming applications, with server 1832(2) being segmented into a higher security segment of application hosting platform 1812. In these examples, central service directory 1824 may detect the movement of third-party application 1816, by monitoring servers of application hosting platform 1812, and may make a change 1838 in the existing database to dynamically update configurations indicating which servers are valid targets for which applications and services. By automatically synching with central service directory 1824, user-mode application 1836 of router 1834 may detect change 1838 and revise security ruleset 1822 to update current rules based on change 1838. In this example, kernel-level security filter 1720 of FIG. 17 may then utilize updated security ruleset 1722 to filter future network traffic. Thus, in this example, user-mode application 1736 may manage the configuration of kernel-level security filter 1720.

In some embodiments, kernel-level security filter 1720 may determine that target location 1726 of intercepted network traffic 1718 does not violate a security rule in security ruleset 1722. In these embodiments, kernel-level security filter 1720 may then forward network traffic 1718 to target location 1726. For example, as illustrated in FIG. 19, kernel-level security filter 1920 of router 1934 may compare target location 1926 of network traffic 1918 to security ruleset 1922. In this example, target location 1926 may be a valid location for a requested application, such as a server 1932 that hosts third-party application 1916. In this example, kernel-level security filter 1920 may approve network traffic 1918, and router 1934 may forward network traffic 1918 to server 1932. For example, router 1934 may automatically redirect any subsequent traffic related to third-party application 1916 from client device 1930 to server 1932. In other words, kernel-level security filter 1920 may determine whether to block or forward network traffic 1918 to target location 1926 based on security ruleset 1922.

As explained above in connection with method 1500 in FIG. 15, the disclosed systems and methods may, by filtering and inspecting all incoming network traffic to a hosting environment, use network security rules to determine whether to block the incoming traffic. Specifically, the disclosed systems and methods may implement a user-mode application that manages a kernel-level security filter. The disclosed systems and methods may enable the user-mode application to dynamically synchronize a security ruleset for the hosting environment with a central services directory. When updates on service and application locations are detected, the disclosed systems and methods may automatically integrate the updates into the central services directory and, subsequently, into the security ruleset. The disclosed systems and methods may then filter traffic with the kernel-level filter by checking the updated security ruleset to determine whether a target location of the network traffic is a valid location for a requested service or application. Additionally, the systems and methods described herein may limit which client devices may access which target locations or segments of the hosting environment.

By maintaining a network isolation ruleset in a dynamic infrastructure, the disclosed systems and methods may protect an application hosting environment that runs untrusted applications from third-party developers against malicious or vulnerable code. Additionally, by using a kernel-level filter, the disclosed systems and methods may reduce the latency traditionally associated with switching between user-mode and kernel-mode applications to meet performance goals. Thus, the systems and methods described herein may improve network traffic filtering for hosting environments as an isolation mechanism.

### Example Systems and Methods for Testing Applications in a Hosting Environment

A cloud-based software distribution platform may provide users with cloud-based access to applications running remotely on the platform. The cloud-based software distribution platform may allow a user to use his or her own device to connect with the platform and access applications as if running natively on the user's device. The platform may further allow the user to run applications regardless of a type or operating system (“OS”) of the user's device as well as an intended operating environment of the application. For example, the user may use a mobile device to run applications designed for a desktop computing environment. Even if the application may not natively be run on the user's device, the platform may provide cloud-based access to the application.

The cloud-based software distribution platform may provide such inter-device application access via nested containers and/or virtual machines (“VM”). For example, the platform may run one or more containers as base virtualization environments, each of which may host a VM as nested virtualization environments. A container may provide an isolated application environment that virtualizes at least an OS of the base host machine by sharing a system or OS kernel with the host machine. A virtual machine may provide an isolated application environment that virtualizes hardware as well as an OS. Although a VM may be more resource-intensive than a container, a VM may virtualize hardware and/or an OS different from the base host machine.

In order to scale cloud-based access to applications, the platform's architecture may include several containers, with a virtual machine running in each container. The use of containers may facilitate scaling of independent virtualized environments, whereas the use of virtual machines may facilitate running applications designed for different application environments. Although the platform may be configured to run applications without requiring significant modification, application developers may wish to test their applications on the platform. However, developers may not readily or feasibly be able to recreate or otherwise access a test or development version of the platform architecture. Moreover, testing applications on the normally accessible cloud platform may cause potential issues that may affect other users of the cloud platform.

The present disclosure is generally directed to testing applications in a cloud application hosting environment. As will be explained in greater detail below, embodiments of the present disclosure may use a limited production instance of the cloud application hosting environment for installing, running, and subsequently removing an application. The systems and methods described herein may improve the functioning of a computer by providing a test environment without requiring additional computing resources. In addition, the systems and methods described herein may improve the field of cloud application hosting by providing close-to-production cloud environment for safely testing applications.

Features from any of the embodiments described herein may be used in combination with one another in accordance with the general principles described herein. These and other embodiments, features, and advantages will be more fully understood upon reading the following detailed description in conjunction with the accompanying drawings and claims.

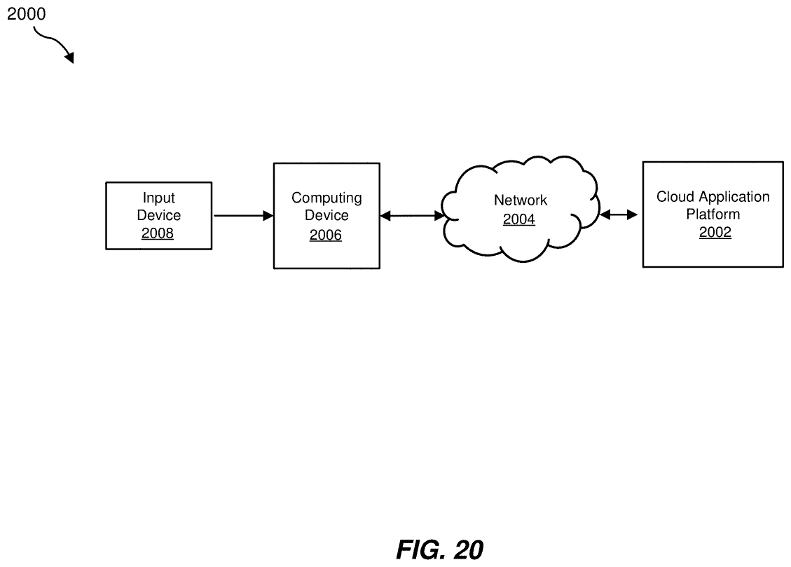

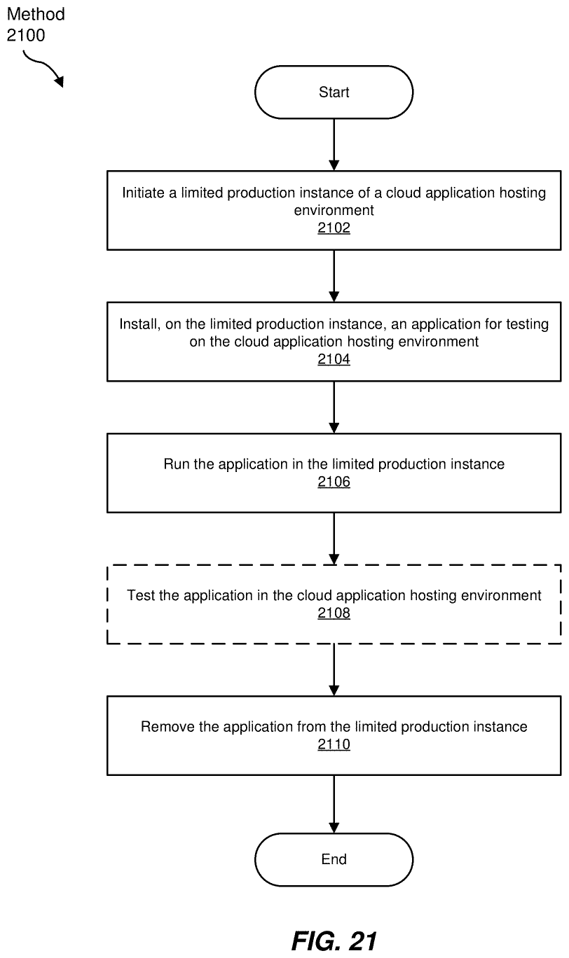

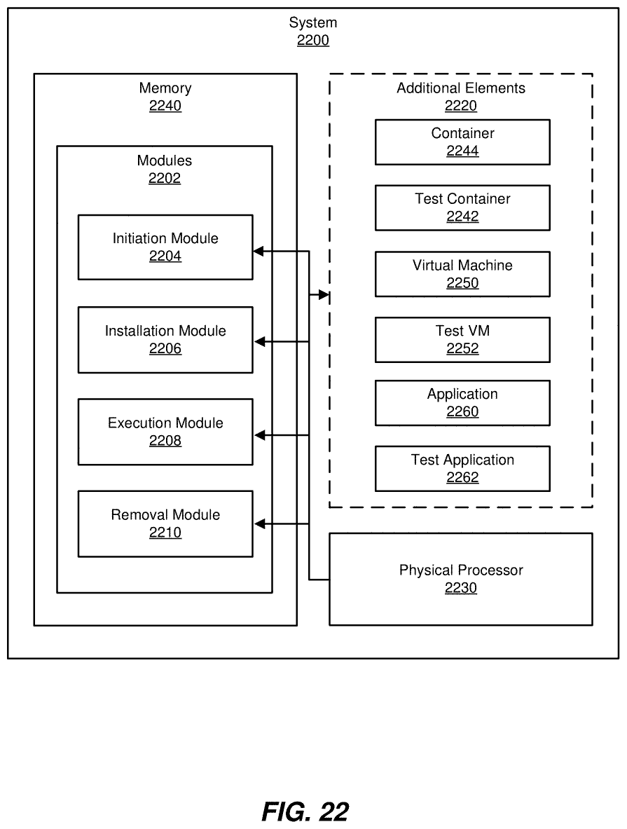

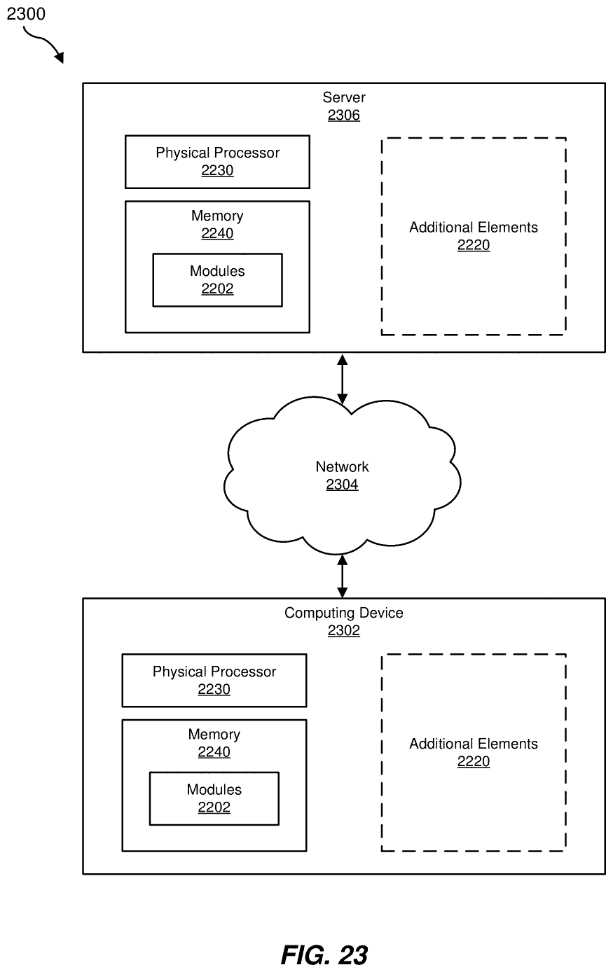

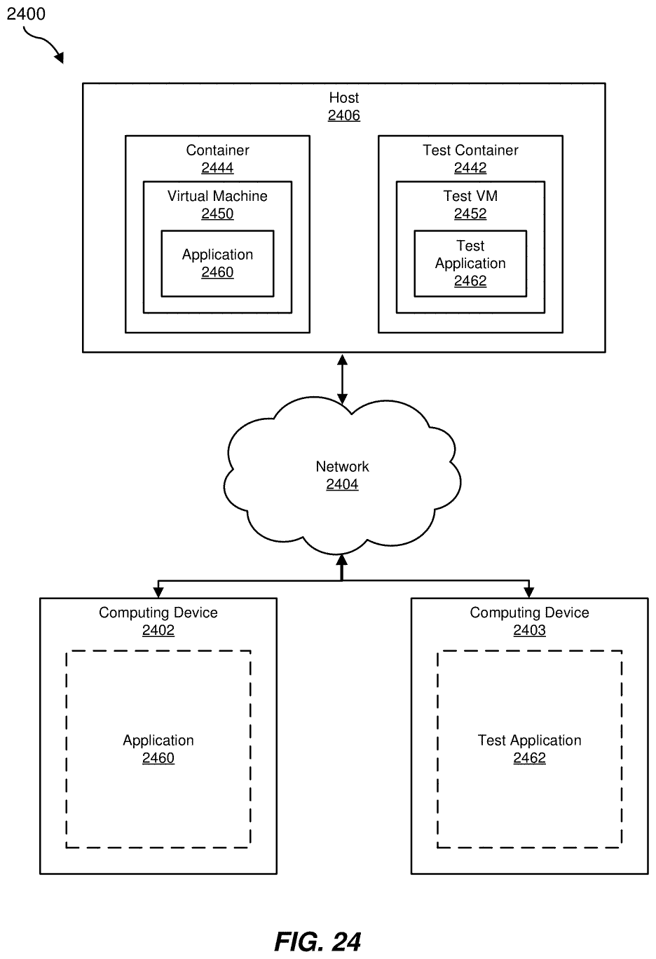

The following will provide, with reference to FIGS. 20-24, detailed descriptions of testing applications on hosting environments. FIG. 20 illustrates an application hosting environment. FIG. 21 illustrates a method for testing application on hosting environments. FIG. 22 illustrates a system for performing the methods described herein. FIG. 23 illustrates a network environment for testing applications on hosting environments. FIG. 24 illustrates a cloud-based software distribution platform.

FIG. 20 is an illustration of an exemplary system 2000 for hosting an application in a hosting or server-side environment. System 2000 may include a cloud application platform 2002 communicating with a computing device 2006 over a network 2004. In some embodiments, the term “server-side” may refer to a classification of resources that run on a server or other suitable platform to generate and/or deliver content over a network to a computing device (e.g., computing device 2006). Cloud application platform 2002 may include servers and other software and hardware to host, run, and/or execute an application in the cloud to provide content to computing device 2006. The content may include, but is not limited to, graphics content and audio content.

In some implementations, network 2004 may be the Internet, a Local Area Network (LAN), a Wide Area Network (WAN), or any type of communication network that implements various types of communication protocols and/or physical connections. Computing device 2006 may be a client device. For example, a user (e.g., an end-user) may interact with computing device 2006 when interfacing with an application executing in cloud application platform 2002. In addition, or in the alternative, a user may view content provided by cloud application platform 2002 that may be presented on a display device included in computing device 2006. Computing device 2006 may receive the content from cloud application platform 2002 in a web browser or other application executing locally on computing device 2006.

A remote device may communicate with, may be connected to (e.g., wired or wirelessly), and/or otherwise be interfaced with an input device. For example, computing device 2006 may be in communication with an input device 2008. In some implementations, the computing device 2006 may include input device 2008. In some implementations, input device 2008 may be in wired or wireless communication with computing device 2006. The wireless communication may be implemented using a wireless communication protocol that may include, but is not limited to, Wi-Fi, BLUETOOTH, cellular, radio, or any other type of wireless communication protocol. Input device 2008 may provide input to computing device 2006. Computing device 2006 may then provide information and data to cloud application platform 2002 by way of the network 2004. Cloud application platform 2002 may use the information and data to control the application executing in cloud application platform 2002. The control of the application may be based, at least in part, on the input received from input device 2008.

A cloud application platform may provide a server-side hosted environment for executing an application (e.g., a cloud-hosted application). For example, cloud application platform 2002 may provide a cloud-hosted infrastructure environment that is architected to include at least one remote server, an execution environment, and hardware for implementing and running a cloud-hosted system for hosting the application. Cloud application platform 2002 may provide various optimizations to allow for enhanced execution of an application not designed to operate in a server-side hosted environment (e.g., an application non-native to the server-side hosted environment (a non-native application or a local application)).

In some implementations, cloud application platform 2002 may virtualize hardware for the server-side hosted environment that is native to the execution environment of an application. The application may then be executed in the server-side hosted environment, which is not native to the application, by the virtualized hardware. The virtualized hardware may enable the application that is non-native to the server-side hosted environment to execute in the server-side hosted environment. In some implementations, cloud application platform 2002 may intercept network calls from the non-native application as it is executing in the server-side environment. Cloud application platform 2002 may map a network call intended for a specified network location in the native execution environment of the application to an updated network location in the server-side hosted environment. In some implementations, cloud application platform 2002 may optimize graphics processing of an application executing in the server-side hosted environment. Cloud application platform 2002 may optimize the non-native application by modifying a video frame of the non-native application for transmission to computing device 2006 during a rendering process. For example, the optimization may change a target characteristic of the video frame.

In some implementations, the application may be a game (e.g., a video game, a gaming application). For example, the game may be an existing game designed to execute on a computing device of a user. For example, the game may be a mobile application. System 2000 may host and provide cloud-delivery for an existing game designed for varying hardware and/or software platforms. The cloud-delivery of the existing game may allow a user to play on the game on the computing device of the user without performance degradation and without the need for substantial modifications to the game.

FIG. 21 is a flow diagram of an exemplary computer-implemented method 2100 for testing applications in a hosting environment. The steps shown in FIG. 21 may be performed by any suitable computer-executable code and/or computing system, including the system(s) illustrated in FIGS. 22 and/or 23. In one example, each of the steps shown in FIG. 21 may represent an algorithm whose structure includes and/or is represented by multiple sub-steps, examples of which will be provided in greater detail below.

As illustrated in FIG. 21, at step 2102 one or more of the systems described herein may initiate a limited production instance of a cloud application hosting environment. For example, an initiation module 2204 in FIG. 22 may initiate a test virtualization environment that may include a test container 2242 and/or a test VM 2252.

In some embodiments, the term “virtualization environment” may refer to an isolated application environment that may virtualize at least some aspects of the application environment such that an application may interface with the virtualized aspects as if running on the application's native environment. Examples of virtualization environments include, without limitation, containers and VMs. In some embodiments, the term “container” may refer to an isolated application environment that virtualizes at least an OS of the base host machine by sharing a system or OS kernel with the host machine. For example, if the base host machine runs Windows (or other desktop OS), the container may also run Windows (or other desktop OS) by sharing the OS kernel such that the container may not require a complete set of OS binaries and libraries. In some embodiments, the term “virtual machine” may refer to an isolated application environment that virtualizes hardware as well as an OS. Because a VM may virtualize hardware, an OS for the VM may not be restricted by the base host machine OS. For example, even if the base host machine is running Windows (or another desktop OS), a VM on the base host machine may be configured to run Android (or other mobile OS) by emulating mobile device hardware. In other examples, other combinations of OSes may be used.

Various systems described herein may perform step 2102. FIG. 22 is a block diagram of an example system 2200 for testing application in a hosting environment. As illustrated in this figure, example system 2200 may include one or more modules 2202 for performing one or more tasks. As will be explained in greater detail herein, modules 2202 may include an initiation module 2204, an installation module 2206, an execution module 2208, and a removal module 2210. Although illustrated as separate elements, one or more of modules 2202 in FIG. 22 may represent portions of a single module or application.

In certain embodiments, one or more of modules 2202 in FIG. 22 may represent one or more software applications or programs that, when executed by a computing device, may cause the computing device to perform one or more tasks. For example, and as will be described in greater detail below, one or more of modules 2202 may represent modules stored and configured to run on one or more computing devices, such as the devices illustrated in FIG. 23 (e.g., computing device 2302 and/or server 2306). One or more of modules 2202 in FIG. 22 may also represent all or portions of one or more special-purpose computers configured to perform one or more tasks.

As illustrated in FIG. 22, example system 2200 may also include one or more memory devices, such as memory 2240. Memory 2240 generally represents any type or form of volatile or non-volatile storage device or medium capable of storing data and/or computer-readable instructions. In one example, memory 2240 may store, load, and/or maintain one or more of modules 2202. Examples of memory 2240 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 22, example system 2200 may also include one or more physical processors, such as physical processor 2230. Physical processor 2230 generally represents any type or form of hardware-implemented processing unit capable of interpreting and/or executing computer-readable instructions. In one example, physical processor 2230 may access and/or modify one or more of modules 2202 stored in memory 2240. Additionally or alternatively, physical processor 2230 may execute one or more of modules 2202 to facilitate maintain the mapping system. Examples of physical processor 2230 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 22, example system 2200 may also include one or more additional elements 2220, such as a container 2244, test container 2242, a virtual machine 2250, test VM 2252, an application 2260, and a test application 2262, one or more of which may be stored on a local storage device, such as memory 2240, or may be accessed remotely. Container 2244 and virtual machine 2250 may represent virtualization environments that may be accessible by users. Test container 2242 and test VM 2252 may represent virtualization environments configured for testing applications, as will be described further below. Application 2260 may represent a hosted application that may be accessible by users. Test application 2262 may represent a development version of an application for testing on the cloud platform.

Example system 2200 in FIG. 22 may be implemented in a variety of ways. For example, all or a portion of example system 2200 may represent portions of example network environment 2300 in FIG. 23.

FIG. 23 illustrates an exemplary network environment 2300 implementing aspects of the present disclosure. The network environment 2300 includes computing device 2302, a network 2304, and server 2306. Computing device 2302 may be a client device or user device, such as a mobile device, a desktop computer, laptop computer, tablet device, smartphone, or other computing device. Computing device 2302 may include a physical processor 2230, which may be one or more processors, memory 2240, which may store data such as one or more of additional elements 2220.

Server 2306 may represent or include one or more servers capable of hosting a cloud-based software distribution platform. Server 2306 may provide cloud-based access to software applications running in virtualization environments. Server 2306 may include a physical processor 2230, which may include one or more processors, memory 2240, which may store modules 2202, and one or more of additional elements 2220.

Computing device 2302 may be communicatively coupled to server 2306 through network 2304. Network 2304 may represent any type or form of communication network, such as the Internet, and may comprise one or more physical connections, such as LAN, and/or wireless connections, such as WAN.

Turning back to method 2100, the systems described herein may perform step 2102 in a variety of ways. In one example, the limited production instance of the cloud application hosting environment may represent a virtualization environment, such as test container 2242, test VM 2252, and/or test VM 2252 nested in test container 2242, that may be similar to a production virtualization environment configured to be accessed by users (e.g., container 2244 and/or virtual machine 2250).

The limited production instance may run applications similarly to production instances but may further include limits that may provide security and isolation from production instances. For example, the limited production instance may include at least one of user role access control, rate limiting (e.g., controlling a rate of requests sent or received, such as network requests and/or other resource requests), or malware scanning. User role access control may include allowing access to a developer of the application. For instance, the user role access control may allow only developers to access the limited production instance to prevent access to general users.

In addition, the limited production instance may be self-contained and separate from other instances of the cloud application hosting environment, for example as illustrated in FIG. 24. FIG. 24 illustrates an exemplary cloud-based software distribution platform 2400. The platform 2400 may include a host 2406, a network 2404 (which may correspond to network 2304), and computing devices 2402 and 2403. Host 2406, which may correspond to server 2306, may include container 2444 (which may correspond to container 2244) and test container 2442 (which may correspond to test container 2242), which may respectively include a virtual machine 2450 (which may correspond to virtual machine 2250) and a test VM 2452 (which may correspond to test VM 2252). Virtual machine 2450 may run an application 2460 (which may correspond to application 2260) and test VM 2452 may run a test application 2462 (which may correspond to test application 2262). Host 2406 may utilize nested virtualization environments (e.g., virtual machine 2450 running in container 2444 and test VM 2452 running in test container 2442) to more efficiently manage virtualization environments. For instance, as a number of VMs are initiated and/or closed the nested virtualization may facilitate management of virtualization environments for various types of VMs as well as more efficiently scale the number of VMs running concurrently. Certain aspects which may be global across certain VMs may be better managed via containers.

Computing device 2402, which may correspond to an instance of computing device 2302, may access application 2460 via network 2404. Computing device 2403, which may correspond to an instance of computing device 2302 and in particular a computing device used by a developer of test application 2462, may access test application 2462 via network 2404. As illustrated in FIG. 24, test container 2442 and/or test VM 2452 may run isolated and independent from container 2444 such that general users (via computing device 2402) may access application 2460 without being impacted by developers (via computing device 2403) testing test application 2462.

Returning to FIG. 21, at step 2104 one or more of the systems described herein may install, on the limited production instance, an application for testing on the cloud application hosting environment. For example, installation module 2206 may install test application 2262 on test VM 2252 (and/or test container 2242).

The systems described herein may perform step 2104 in a variety of ways. In one example, installing the application may include receiving an upload of the application. The upload may include a binary or otherwise executable version of the application although in some examples, the upload may include source code. For example, installation module 2206 may receive an upload of test application 2462 from computing device 2403.

Installation module 2206 may build an ephemeral package from the upload. The ephemeral package may be configured to not persist and instead expire (e.g., after a period of time or other trigger condition such as ending execution), at which point may become non-accessible (e.g., may self-delete or become non-executable). Installation module 2206 may install the ephemeral package of the application on the limited production instance. Thus, in some examples, test application 2462 may be an ephemeral package installed on test VM 2452 and/or test container 2442.

At step 2106 one or more of the systems described herein may run the application in the limited production instance. For example, execution module 2208 may run test application 2262 in test VM 2252 and/or test container 2242.

The systems described herein may perform step 2106 in a variety of ways. In one example, test application 2462 may run on test VM 2452 or test container 2442.

Optionally at step 2108 one or more of the systems described herein may test the application in the cloud application hosting environment. For example, execution module 2208 may run tests such as debugging tests on test application 2262.

The systems described herein may perform step 2108 in a variety of ways. In one example, execution module 2208 may perform a series of tests on test application 2462. The tests may be automated and/or manually configured to test various aspects of test application 2462. In some examples, the tests may include experimentation and validation of changes. For example, a developer (using computing device 2403) may manually or via automated tools change certain aspects of test application 2462, observe the behavior of test application 2462 running on test VM 2452 (and/or test container 2442), and modify test application 2462 based on the observed results. By accessing, via computing device 2403, test application 2462 running on test VM 2452 (and/or test container 2442), the developer may be able to observe test application 2462 running on a close-to-production instance of the cloud platform for more accurate testing and/or debugging.

Turning back to FIG. 21, at step 2110 one or more of the systems described herein may remove the application from the limited production instance. Removal module 2210 may remove test application 2262, for instance by deleting test application 2262.

The systems described herein may perform step 2110 in a variety of ways. In one example, removing the application may include removing the ephemeral package from the limited production instance. Test application 2462 may be an ephemeral package, as described above, and may self-delete upon expiring. Test application 2462 may expire, for example, when test application 2462 completes execution, the limited production instance ends (e.g., test VM 2452 and/or test container 2442 terminates), a predetermined period of time elapses, or is otherwise instructed to expire. Thus, test application 2462 may not leave any significant data on host 2406 when the test session ends.

As described herein, a cloud hosting environment may have a unique setup or architecture that may be unfeasible to duplicate in a developer's local environment. The systems and methods described herein may allow application developers to test uploaded application binaries in a close-to-production cloud environment without exposure to or otherwise affecting public users. The systems described herein may build ephemeral packages and installs the ephemeral packages on the fly on the cloud host. The systems described herein may only allow authorized developers to test the application on different platforms (e.g., desktop browser, mobile OSes), and may clean up after the session. Additional security may be provided using rate limiting and user role access control.

### Example Systems and Methods for Supporting Multi-touch Applications

The present disclosure is generally directed to a system that enables mobile games or other applications that require multi-touch support (e.g., pinch-stretch for zoom, rotation, etc.) to be usable on devices such as desktops or laptops that don't have a touch screen. In one embodiment, the system may enable a user to use a mouse and keyboard to mimic the input gestures via a multi-touch overlay. For example, moving the main “finger” that is controlled by a mouse may also move the second “finger,” ensuring that they are always center-symmetric on the screen. In one example, a click event on the main “finger” via mouse may trigger a click event on the second “finger” as well as release or hold events. This may enable pinch-stretch and rotation by an input device that has only one touching point, such as a laptop or desktop mouse. In some examples, the system may enable a mobile game to be immediately playable in a web browser without requiring developers to rewrite the game without multi-touch.

In some embodiments, the systems described herein may improve the functioning of a computing device by enabling the computing device to provide multi-touch input to applications despite the computing device's lack of hardware to support multi-touch input (e.g., a touchscreen). Additionally, the systems described herein may improve the fields of app development and/or game development by enabling developers and/or publishers to easily port mobile apps or other apps designed to receive multi-touch input to devices such as laptops and desktops that do not natively support multi-touch input without requiring the applications to be rewritten to receive single-point input.

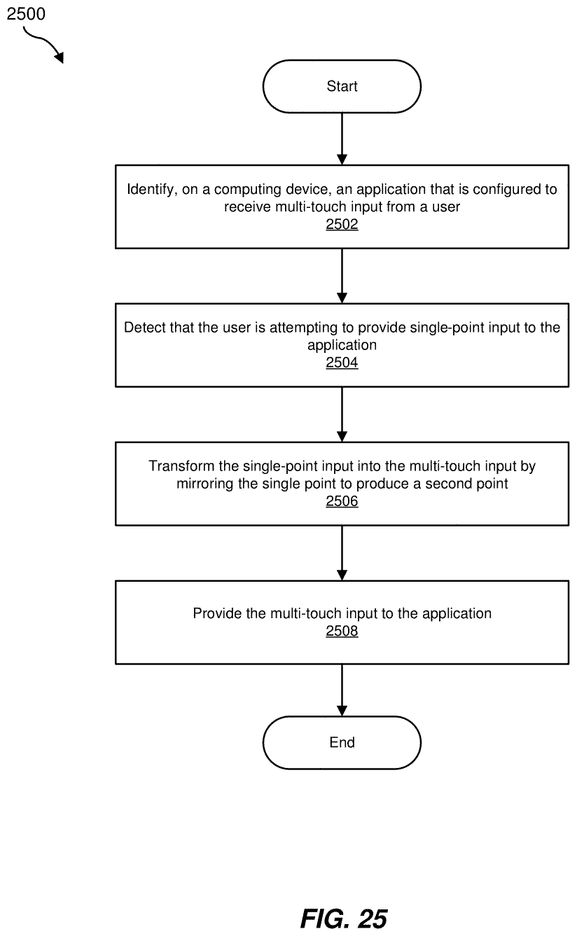

FIG. 25 is a flow diagram of an exemplary method 2500 for supporting multi-touch applications. In some examples, at step 2502, the systems described herein may identify, on a computing device, an application that is configured to receive multi-touch input from a user. In some examples, the systems described herein may identify an application running in a web browser. In other examples, the systems described herein may identify a standalone application (e.g., an executable file). In some embodiments, the systems described herein may determine that the application is configured to receive multi-touch input based on detecting the file type of the application, analyzing metadata included with the application, receiving user input identifying the application, and/or monitoring requests made by the application.

At step 2504, the systems described herein may detect that the user is attempting to provide single-point input to the application. For example, the systems described herein may detect that the user is hovering a cursor over the user interface of the application and/or has clicked on the user interface of the application with a cursor. In some examples, the systems described herein may detect that the user is in the process of clicking and dragging (e.g., clicking and moving the cursor with a mouse button and/or keyboard key depressed) within the application user interface.

At step 2506, the systems described herein may transforming the single-point input into the multi-touch input by mirroring the single point to produce a second point. The systems described herein may mirror the single point in a variety of ways.

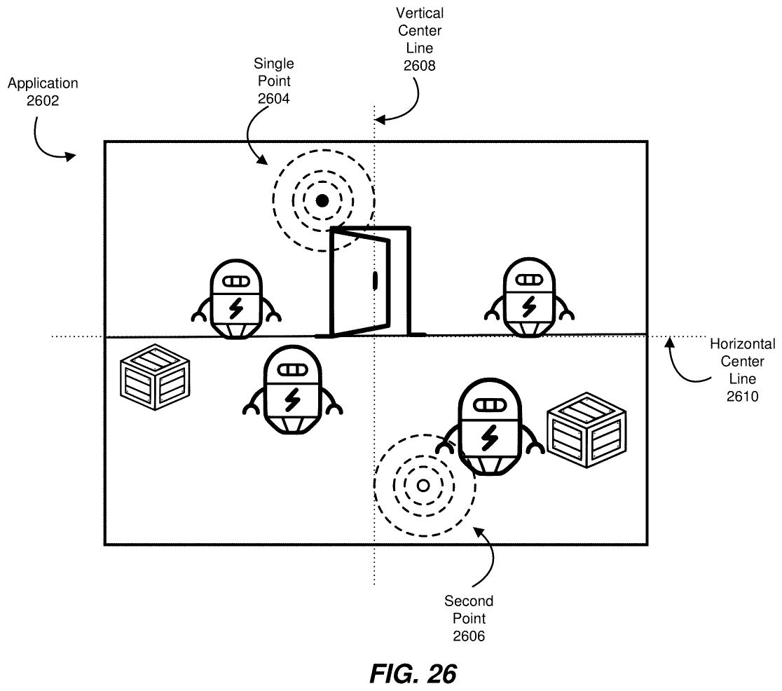

In one example, the systems described herein may mirror the single point over a central point or line of the application's user interface. For example, as illustrated in FIG. 26, the systems described herein may mirror a single point 2604 over a horizontal center line 2610 and/or a vertical center line 2608 to create a second point 2606 within an application 2602. In some examples, mirroring the single point over the center of the application may enable the user to zoom in or out using the application's native pinch-to-zoom functionality (e.g., pinch to zoom in and/or stretch to zoom out) by clicking and dragging towards or away from the center of the application's user interface.

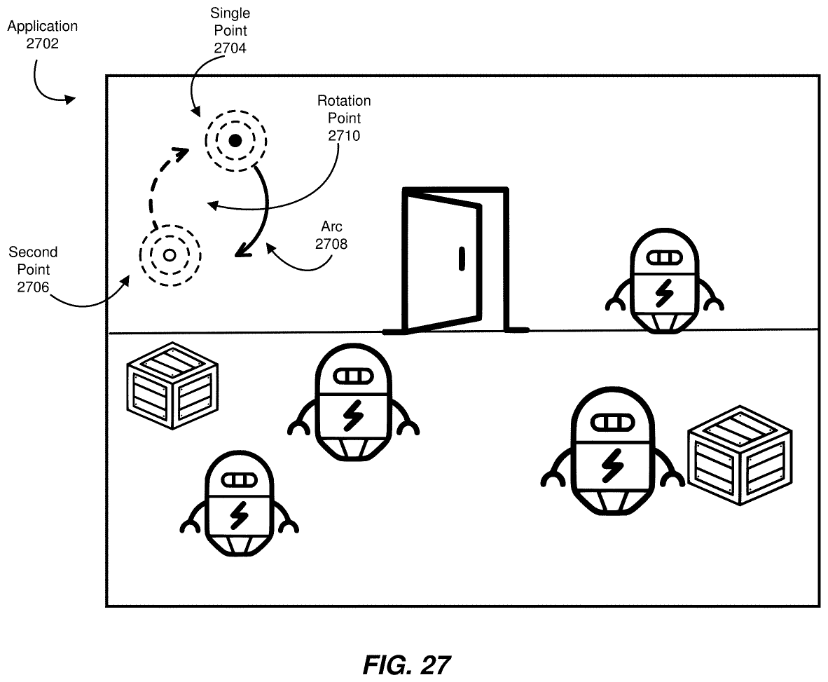

Additionally or alternatively, the systems described herein may mirror the single point rotationally around a point determined by the movement of the cursor. For example, as illustrated in FIG. 27, the systems described herein may detect that a single point 2704 is being moved along an arc 2708. In response, the systems described herein may calculate a rotation point 2710 based on arc 2708 and may mirror single point 2704 rotationally across rotation point 2710 to create a second point 2706 moving in an arc that rotationally mirrors arc 2708. This may enable the user to rotate an element within the user interface of application 2702 (e.g., an item, an avatar, the entire display, etc.) around rotation point 2710.

In some embodiments, the systems designed herein may display a multi-touch overlay that includes the location of the second point. For example, the systems described herein may show the location of the first point and/or artificially generated second point in a visual overlay similar to the illustrations in FIGS. 26 and 27.

Returning to FIG. 25, at step 2508, the systems described herein may provide the multi-touch input to the application. In some embodiments, the systems described herein may determine a format in which the application expects to receive multi-touch input and/or may combine the original single-point input with the artificially generated second point to the application as if the input is multi-touch input generated by a touch screen.

### Example Optimized Graphics Rendering

A cloud gaming platform may leverage the same graphics processing (GPU) unit both for game rendering and for video encoding. For security reasons, the game rendering and the video encoding may occur through different processes. In some embodiments, these two may also occur within different containers. The present disclosure is generally directed to an optimized GPU pipeline that minimizes memory copies between the central processing unit (GPU) and the GPU. This minimization may benefit both latency and efficiency. In one embodiment, the optimized GPU pipeline may be implemented through the Computing Unified Device Architecture (CUDA). In particular, the systems described herein may leverage a headless GL-CUDA texture capture and CUDA IPC to share the memory of the GPU between rendering and encoding. In some embodiments, this memory may be shared across processes and across containers.

Features from any of the embodiments described herein may be used in combination with one another in accordance with the general principles described herein. These and other embodiments, features, and advantages will be more fully understood upon reading the following detailed description in conjunction with the accompanying drawings and claims.

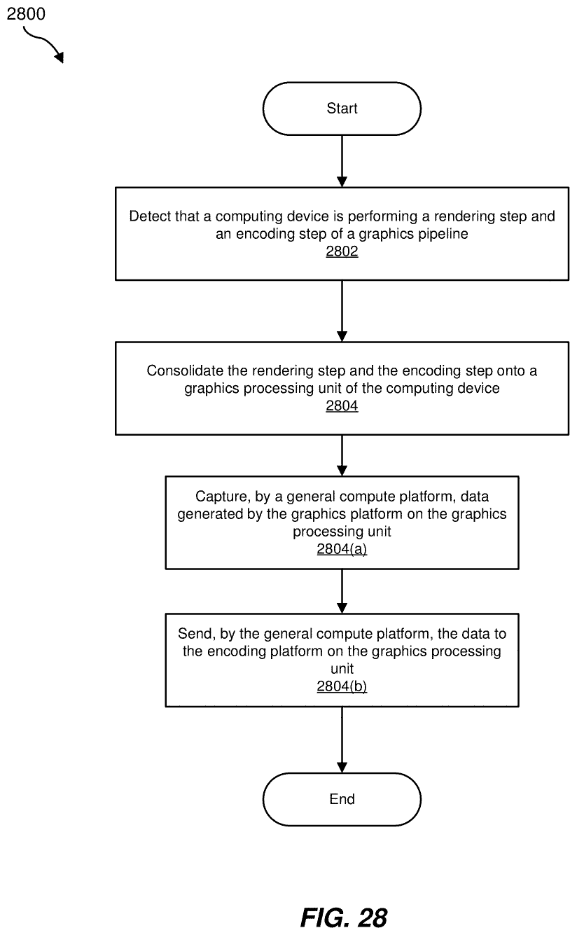

FIG. 28 is a flow diagram of an exemplary computer-implemented method 2800 for optimizing graphics processing. The steps shown in FIG. 28 may be performed by any suitable computer-executable code and/or computing system. In one example, each of the steps shown in FIG. 28 may represent an algorithm whose structure includes and/or is represented by multiple sub-steps, examples of which will be provided in greater detail below.

As illustrated in FIG. 28, at step 2802 one or more of the systems described herein may detect that a computing device is performing a rendering step and an encoding step of a graphics pipeline. The term “graphics pipeline” or “graphics rendering pipeline” may generally refer to a combination of hardware, software, containers, and/or processes that produces rendered graphics as output. At step 2804, one or more of the systems described herein may consolidate the rendering step and the encoding step onto a GPU of the computing device by, at step 2804(a), capturing, by a general compute platform, data generated by the graphics platform on the GPU and at step 2804(b) sending, by the general compute platform, the data to the encoding platform on the GPU. The term “rendering step” may generally refer to any computing action or set of actions that transforms data into rendered graphics. The term “graphics platform” may generally refer to any hardware and/or software that perform a rendering step and/or related steps as part of a graphics pipeline. In one embodiment, a graphics platform may include an emulator (e.g., a virtual machine). The term “encoding platform” may generally refer to any hardware and/or software that performs encoding of media, such as video encoding. The term “compute platform” may generally refer to any module that enables a computing device to perform general-purpose computing on a GPU.

In some embodiments, a graphics rendering pipeline may include an emulator that performs rendering and an encoding platform that performs encoding and/or additional tasks, such as pipeline setup, overlay, and/or a transform step. In some embodiments, the systems described herein may be designed and/or configured to minimize GPU-CPU memory transfers and/or CPU memory copies in order to improve latency and/or efficiency. In one embodiment, the systems described herein may implement encoding-related logic inside the emulator to facilitate data transfer between the emulator and encoding platform. For example, the systems described herein may can re-use an emulator console channel and/or an existing shared memory channel to feed encoding parameters such as rate control back to the emulator. Additionally or alternatively, the systems described herein may keep all encoding logic within the encoding platform and use inter-process communication (IPC) to share device memory handles across processes.

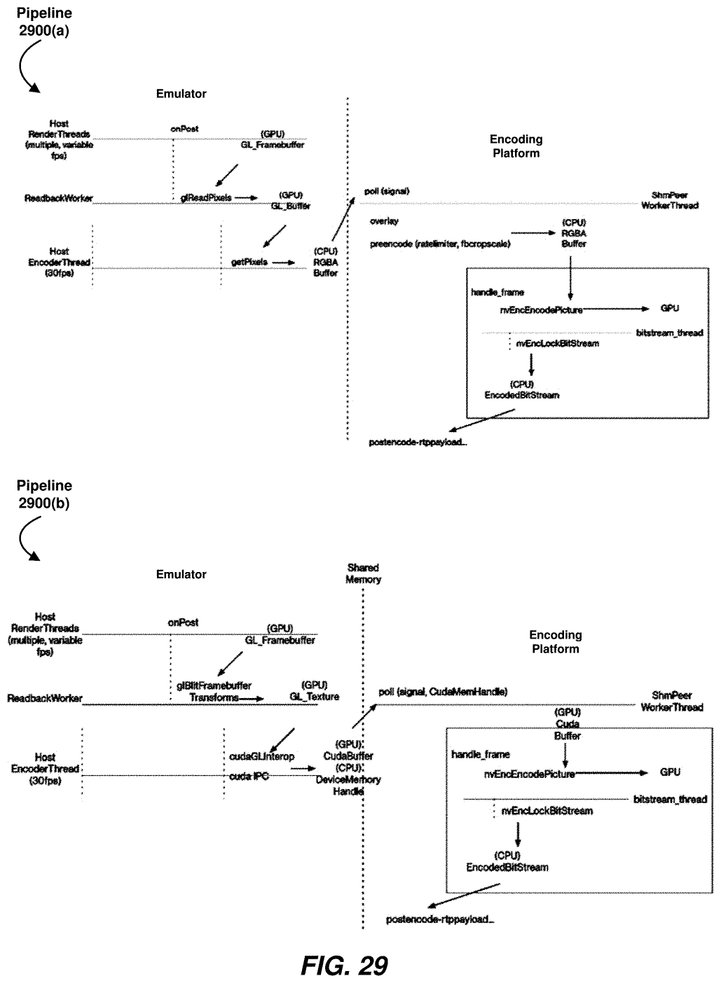

In some embodiments, the systems described herein may use a compute unified device architecture (CUDA) module to facilitate data transfer between an emulator and an encoding platform. For example, as illustrated in FIG. 29, a pipeline 2900(a) may include multiple transfers of data and/or processing from a GPU to a CPU and back, introducing inefficiency and/or latency. By contrast, a pipeline 2900(b) may use a CUDA module to capture data from the emulator and send the data to the encoder, enabling the encoder to perform encoding on the GPU instead of the CPU, minimizing memory copies and/or latency. In one embodiment, the systems described herein may include an optimized GPU pipeline based on headless GL-CUDA texture capture and/or CUDA IPC to share the GPU memory between rendering and encoding across processes and/or across containers.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive video and/or application data to be transformed, transform the data, output a result of the transformation to improve video and/or cloud application quality, use the result of the transformation to improve video and/or cloud application performance, and store the result of the transformation to improve quality and/or performance of video and/or applications. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
a processor; and
a memory device comprising instructions that, when executed by the processor, perform at least one of:
a process for monitoring end-to-end video quality based on at least one of a scaled perceptual quality score or an interpolated perceptual quality score, the quality scores being across various video views, and the process comprising:
identifying a video that has been uploaded to a video server for delivery to at least one viewing device;
identifying an original resolution of the video uploaded to the video server;
generating, from the video, at least one adaptive bitrate encoding of another resolution that differs from the original resolution;
scaling the original video data and the adaptive bitrate encoding to at least one viewport resolution that differs from the original resolution and the another resolution;
computing at least one full-reference metric based at least in part on:
the original video data; or
the adaptive bitrate encodings; and
monitoring a quality of the video delivered to the viewing device based at least in part on the full-reference metric; or
a process for improving a search experience for a user expectation, the process comprising:
receiving a query from a user;
classifying the query into one or more categories;
identifying the user expectation for the query based on the one or more categories;
determining search results matching the query;
ranking the search results based on the user expectation; and
providing the ranked search results to the user; or
a process for providing hardware virtualization and simulation for server hosting, the process comprising:
identifying an execution environment for an application designed to execute on a computing device, the application being non-native to a server-side hosted environment; and
implementing a hardware and software runtime instance in the server-side hosted environment that supports the execution of the application, the implementing comprising simulating the execution environment for the application by virtualizing hardware for the server-side hosted environment that supports the execution of the application in the server-side hosted environment; or
a process for filtering network traffic in a hosting environment comprising:
intercepting, by a kernel-level security filter of an application hosting platform, network traffic related to a third-party application;
identifying a security ruleset of the application hosting platform, wherein the security ruleset is dynamically synced with a central service directory;
inspecting, by the kernel-level security filter, a target location of the intercepted network traffic;
determining, by the kernel-level security filter, that the target location violates at least one security rule in the security ruleset; and
blocking the network traffic based on the determination; or
a process for testing applications in a hosting environment comprising:
initiating a limited production instance of a cloud application hosting environment;
installing, on the limited production instance, an application for testing on the cloud application hosting environment;
running the application in the limited production instance; and
removing the application from the limited production instance; or
a process for supporting multi-touch applications comprising:
identifying, on a computing device, an application that is configured to receive multi-touch input from a user;
detecting that the user is attempting to provide single-point input to the application;
transforming the single-point input into the multi-touch input by mirroring the single point to produce a second point; and
providing the multi-touch input to the application; or
a process for optimized graphics rendering comprising:
detecting that a computing device is performing a rendering step and an encoding step of a graphics pipeline, wherein the rendering step is performed by a graphics platform and the encoding step is performed by an encoding platform; and
consolidating the rendering step and the encoding step onto a graphics processing unit of the computing device by:
capturing, by a general compute platform, data generated by the graphics platform on the graphics processing unit; and
sending, by the general compute platform, the data to the encoding platform on the graphics processing unit.

2. The method of claim 1, wherein the process for monitoring the end-to-end video quality further comprises:
receiving, at the video server, information about a viewing screen resolution from the viewing device;
determining that the viewing screen resolution differs from the viewport resolution based at least in part on the information; and
interpolating the information about the screen resolution into the computation of the full-reference metric to account for the difference between the viewing screen resolution and the viewport resolution.

3. The method of claim 1, wherein:
monitoring the quality of the video comprises identifying at least one inefficiency in the delivery of the video based at least in part on the full-reference metric; and
wherein the process for monitoring the end-to-end video quality further comprises modifying the quality of the video delivered to the viewing device to account for the inefficiency.

4. The method of claim 1, wherein the process for improving a search experience for a user expectation further comprises logging the query, the user, and the user expectation.

5. The method of claim 1, wherein identifying the user expectation is based on success data from at least one basic verification test (BVT) testing previously logged users, queries, and user expectations.

6. The method of claim 1, wherein classifying the query is based on at least one of a social graph of the user, or a previous search history of the user.

7. The method of claim 1, wherein simulating the execution environment for the application by virtualizing hardware for the server-side hosted environment that supports the execution of the application in the server-side hosted environment comprises providing a container in the server-side hosted environment in which to execute the application.

8. The method of claim 1, wherein implementing the hardware and software runtime further comprises standardizing the simulated execution environment such that a performance measure for the execution of the application in the server-side hosted environment is independent of server hardware that runs the hardware and software runtime instance of the application.

9. The method of claim 1, further comprising:
managing, by a user-mode application, the kernel-level security filter;
monitoring, by the user-mode application, the central service directory;
detecting, by the user-mode application, a change to the central service directory; and
updating the security ruleset based on the detected change to the central service directory.

10. The method of claim 1, further comprising:
determining, by the kernel-level security filter, that the target location of the intercepted network traffic does not violate a security rule in the security ruleset; and
forwarding the intercepted network traffic to the target location.

11. The method of claim 1, wherein the limited production instance of the cloud application hosting environment includes at least one of user role access control, rate limiting, or malware scanning, and
the user role access control includes allowing access to a developer of the application.

12. The method of claim 1, wherein installing the application comprises:
receiving an upload of the application;
building an ephemeral package from the upload;
installing the ephemeral package on the limited production instance; and
wherein removing the application comprises removing the ephemeral package from the limited production instance.

13. The method of claim 1, wherein the limited production instance is self-contained and separate from other instances of the cloud application hosting environment; and
wherein running the application comprises testing the application in the cloud application hosting environment.

14. The computer-implemented method of claim 1, wherein transforming the single-point input into the multi-touch input comprises displaying, to the user, a multi-touch overlay that comprises a location of the second point.

15. The computer-implemented method of claim 1, wherein the application is configured to receive the multi-touch input via a touchscreen and the computing device does not comprise the touchscreen.

16. The computer-implemented method of claim 1, wherein consolidating the rendering step and the encoding step onto the graphic processing unit of the computing device comprises performing at least one step of the graphics pipeline on the graphics processing unit instead of on a central processing unit of the computing device.

17. The computer-implemented method of claim 1, wherein consolidating the rendering step and the encoding step onto the graphic processing unit of the computing device comprises consolidating memories copies of the data across at least two containers.

18. The computer-implemented method of claim 1, wherein consolidating the rendering step and the encoding step onto the graphic processing unit of the computing device comprises consolidating memories copies of the data across at least two computing processes.

19. A system comprising:
at least one physical processor;
physical memory comprising computer-executable instructions that, when executed by the physical processor, cause the physical processor to perform at least one of:
a process for monitoring end-to-end video quality based on at least one of a scaled perceptual quality score or an interpolated perceptual quality score, the quality scores being across various video views, and the process comprising:
identifying a video that has been uploaded to a video server for delivery to at least one viewing device;
identifying an original resolution of the video uploaded to the video server;
generating, from the video, at least one adaptive bitrate encoding of another resolution that differs from the original resolution;
scaling the original video data and the adaptive bitrate encoding to at least one viewport resolution that differs from the original resolution and the another resolution;
computing at least one full-reference metric based at least in part on:
the original video data; or
the adaptive bitrate encodings; and
monitoring a quality of the video delivered to the viewing device based at least in part on the full-reference metric; or
a process for improving a search experience for a user expectation, the process comprising:
receiving a query from a user;
classifying the query into one or more categories;
identifying the user expectation for the query based on the one or more categories;
determining search results matching the query;
ranking the search results based on the user expectation; and
providing the ranked search results to the user; or
a process for providing hardware virtualization and simulation for server hosting, the process comprising:
identifying an execution environment for an application designed to execute on a computing device, the application being non-native to a server-side hosted environment; and
implementing a hardware and software runtime instance in the server-side hosted environment that supports the execution of the application, the implementing comprising simulating the execution environment for the application by virtualizing hardware for the server-side hosted environment that supports the execution of the application in the server-side hosted environment; or
a process for filtering network traffic in a hosting environment comprising:
intercepting, by a kernel-level security filter of an application hosting platform, network traffic related to a third-party application;
identifying a security ruleset of the application hosting platform, wherein the security ruleset is dynamically synced with a central service directory;
inspecting, by the kernel-level security filter, a target location of the intercepted network traffic;
determining, by the kernel-level security filter, that the target location violates at least one security rule in the security ruleset; and
blocking the network traffic based on the determination; or
a process for testing applications in a hosting environment comprising:
initiating a limited production instance of a cloud application hosting environment;
installing, on the limited production instance, an application for testing on the cloud application hosting environment;
running the application in the limited production instance; and
removing the application from the limited production instance; or
a process for supporting multi-touch applications comprising:
identifying, on a computing device, an application that is configured to receive multi-touch input from a user;
detecting that the user is attempting to provide single-point input to the application;
transforming the single-point input into the multi-touch input by mirroring the single point to produce a second point; and
providing the multi-touch input to the application; or
a process for optimized graphics rendering comprising:
detecting that a computing device is performing a rendering step and an encoding step of a graphics pipeline, wherein the rendering step is performed by a graphics platform and the encoding step is performed by an encoding platform; and
consolidating the rendering step and the encoding step onto a graphics processing unit of the computing device by:
capturing, by a general compute platform, data generated by the graphics platform on the graphics processing unit; and
sending, by the general compute platform, the data to the encoding platform on the graphics processing unit.

20. A non-transitory computer-readable medium comprising one or more computer-executable instructions that, when executed by at least one processor of a computing device, cause the computing device to perform at least one of:
a process for monitoring end-to-end video quality based on at least one of a scaled perceptual quality score or an interpolated perceptual quality score, the quality scores being across various video views, and the process comprising:
identifying a video that has been uploaded to a video server for delivery to at least one viewing device;
identifying an original resolution of the video uploaded to the video server;
generating, from the video, at least one adaptive bitrate encoding of another resolution that differs from the original resolution;
scaling the original video data and the adaptive bitrate encoding to at least one viewport resolution that differs from the original resolution and the another resolution;
computing at least one full-reference metric based at least in part on:
the original video data; or
the adaptive bitrate encodings; and
monitoring a quality of the video delivered to the viewing device based at least in part on the full-reference metric; or
a process for improving a search experience for a user expectation, the process comprising:
receiving a query from a user;
classifying the query into one or more categories;
identifying the user expectation for the query based on the one or more categories;
determining search results matching the query;
ranking the search results based on the user expectation; and
providing the ranked search results to the user; or
a process for providing hardware virtualization and simulation for server hosting, the process comprising:
identifying an execution environment for an application designed to execute on a computing device, the application being non-native to a server-side hosted environment; and
implementing a hardware and software runtime instance in the server-side hosted environment that supports the execution of the application, the implementing comprising simulating the execution environment for the application by virtualizing hardware for the server-side hosted environment that supports the execution of the application in the server-side hosted environment; or
a process for filtering network traffic in a hosting environment comprising:
intercepting, by a kernel-level security filter of an application hosting platform, network traffic related to a third-party application;
identifying a security ruleset of the application hosting platform, wherein the security ruleset is dynamically synced with a central service directory;
inspecting, by the kernel-level security filter, a target location of the intercepted network traffic;
determining, by the kernel-level security filter, that the target location violates at least one security rule in the security ruleset; and
blocking the network traffic based on the determination; or
a process for testing applications in a hosting environment comprising:
initiating a limited production instance of a cloud application hosting environment;
installing, on the limited production instance, an application for testing on the cloud application hosting environment;
running the application in the limited production instance; and
removing the application from the limited production instance; or
a process for supporting multi-touch applications comprising:
identifying, on a computing device, an application that is configured to receive multi-touch input from a user;
detecting that the user is attempting to provide single-point input to the application;
transforming the single-point input into the multi-touch input by mirroring the single point to produce a second point; and
providing the multi-touch input to the application; or
a process for optimized graphics rendering comprising:
detecting that a computing device is performing a rendering step and an encoding step of a graphics pipeline, wherein the rendering step is performed by a graphics platform and the encoding step is performed by an encoding platform; and
consolidating the rendering step and the encoding step onto a graphics processing unit of the computing device by:
capturing, by a general compute platform, data generated by the graphics platform on the graphics processing unit; and
sending, by the general compute platform, the data to the encoding platform on the graphics processing unit.
